(19) United States
(12) Patent Application Publication
(10) Pub. No.: US 2024/0312166 A1
(43) Pub. Date: Sep. 19, 2024

(54) ROTATION, INPAINTING AND COMPLETION FOR GENERALIZABLE SCENE COMPLETION

(71) Applicant: SAMSUNG ELECTRONICS CO., LTD., Suwon-si (KR)

(72) Inventors: Isaac Hisanao KASAHARA, Brooklyn, NY (US); Shubham AGRAWAL, Jersey City, NJ (US); Kazim Selim ENGIN, Weehawken, NJ (US); Nikhil Narsingh CHAVAN DAFLE, Jersey City, NY (US); Shuran SONG, New York, NY (US); Ibrahim Volkan ISLER, Saint Paul, MN (US)

(73) Assignee: SAMSUNG ELECTRONICS CO., LTD., Suwon-si (KR)

(21) Appl. No.: 18/400,889

(22) Filed: Dec. 29, 2023

Related U.S. Application Data
(60) Provisional application No. 63/452,059, filed on Mar. 14, 2023.

(51) Int. Cl. G06T 19/20; G05D 1/622; G06T 5/77; G06T 7/13; G06T 15/10; G06T 15/40; G06T 17/20

(52) U.S. Cl. CPC G06T 19/20; G05D 1/622; G06T 5/77; G06T 7/13; G06T 15/10; G06T 15/40; G06T 17/20; G05D 2101/15; G05D 2105/10; G06T 2207/10024; G06T 2207/10028; G06T 2207/20081; G06T 2210/56; G06T 2219/004; G06T 2219/2012; G06T 2219/2016

(57) ABSTRACT

Methods and devices for processing image data for scene completion, including receiving an original image from an original viewpoint corresponding to a first direction, wherein the original image includes an object; obtaining a first image from a new viewpoint corresponding to a second direction different from the first direction by rotating the original image based on 3-dimensional (3D) information generated from 2-dimensional (2D) information which is obtained from the original image; determining an area within the first image for generating a second surface of the object based on depth information about a depth between the object and the background of the original image, wherein the determined area is expected to include an object area; and obtaining a second image by inputting the first image and the determined area to an artificial intelligence (AI) inpainting model, wherein the AI inpainting model generates the second surface of the object which occupies a portion of the determined area in the second image.

### CROSS-REFERENCE TO RELATED APPLICATION(S)

This application is based on and claims priority under 35 U.S.C. § 119 to U.S. Provisional Patent Application No. 63/452,059, filed on Mar. 14, 2023, in the U.S. Patent & Trademark Office, the disclosure of which is incorporated by reference herein in its entirety.

### BACKGROUND

### 1. Field

The disclosure relates to a method for processing an image, and an apparatus for the same, and more particularly to a method for performing masking and inpainting for generalizable scene completion, and an apparatus for the same.

### 2. Description of Related Art

Building three-dimensional (3D) structures of scenes may be important for many applications, for example robot navigation, planning, manipulation, and interaction. Improvements in 3D perception capabilities have accompanied the increasing availability of depth sensors on smartphones and robots. However, a complete and coherent reconstruction is challenging when only partial observation of the scene is available.

The task of estimating the full 3D geometry of a scene containing unseen objects, from a single red, green, blue plus depth (RGB-D) image may be referred to as general or generalizable scene completion. Scene completion is an important task which may allow for better robot action planning such as grasp planning, path planning, and long-horizon task planning. Scene completion may also be useful in contexts such as autonomous navigation and image generation for augmented reality (AR) and virtual reality (VR) devices. However, a single view of the environment may capture only limited information of the scene, which presents a major challenge for scene completion.

### SUMMARY

Example embodiments address at least the above problems and/or disadvantages and other disadvantages not described above. Also, the example embodiments are not required to overcome the disadvantages described above, and may not overcome any of the problems described above.

In accordance with an aspect of the disclosure, a method for processing image data for scene completion is executed by at least one processor and includes receiving an original image from an original viewpoint corresponding to a first direction, wherein the original image includes an object and a background, wherein a first surface of the object is an image of the object corresponding to the first direction; obtaining a first image from a new viewpoint corresponding to a second direction different from the first direction by rotating the original image based on 3-dimensional (3D) information generated from 2-dimensional (2D) information which is obtained from the original image; determining an area within the first image for generating a second surface of the object based on depth information about a depth between the object and the background of the original image; and obtaining a second image by inputting the first image and the determined area to an artificial intelligence (AI) inpainting model, wherein the AI inpainting model generates the second surface of the object which occupies a portion of the determined area in the second image.

The method may further include rendering an incomplete color image and an incomplete depth image corresponding to the new viewpoint based on the 3D information; masking a portion of the incomplete color image based on the 3D information and the incomplete depth image to obtain a masked color image, wherein the masked portion of the incomplete color image corresponds to the determined area and indicates that the masked portion of the incomplete color image is obscured by the object when the scene is viewed from the new viewpoint; and inpainting the masked color image to obtain the second image.

The obtaining the second image may include: inpainting the masked color image based on the AI inpainting model to obtain the second image.

The method may further include obtaining an image caption by providing the second image to an AI caption model; and determining whether to re-inpaint the second image by comparing an embedding of the image caption and an embedding of the prompt.

The method may further include masking a portion of the incomplete depth image based on the 3D information and the incomplete depth image to obtain a masked depth image, wherein the masked portion of the incomplete depth image corresponds to the determined area; providing the second image to an AI depth estimation model; generating an estimated depth image based on the masked depth image and an output of the AI depth estimation model; and generating a completed 3D representation based on the second image and the estimated depth image.

The generating the estimated depth image may include: obtaining at least one estimated normal and at least one estimated occlusion boundary by providing the second image to the AI depth estimation model; and obtaining the estimated depth image based on the incomplete depth image, the at least one estimated normal, and the at least one estimated occlusion boundary.

The method may further include rendering a plurality of incomplete color images and a plurality of incomplete depth images from a plurality of new viewpoints based on the 3D information; masking the plurality of incomplete color images to obtain a plurality of masked color images, and masking the plurality of incomplete depth images to obtain a plurality of masked depth images; obtaining a plurality of second images by providing the plurality of masked color images to the AI inpainting model; providing the plurality of second images to the AI depth estimation model; and obtaining a plurality of estimated depth images based on the plurality of masked depth images and a plurality of outputs of the AI depth estimation model, and the completed 3D representation may be further generated based on the plurality of second images and the plurality of estimated depth images.

The generating of the completed 3D representation may include: generating a plurality of estimated point clouds based on the second image, the estimated depth image, the plurality of second images, and the plurality of estimated depth images; and merging the plurality of estimated point clouds by discarding points which are not included in at least two estimated point clouds from among the plurality of estimated point clouds to obtain a completed scene point cloud representing the scene.

The masking may include: generating a plurality of points which extend beyond a surface included in the original image; generating a mesh based on the plurality of points; rendering a depth map representing the mesh from the new viewpoint; generating a mask based on a comparison between the incomplete depth image and the depth map; and applying the mask to the incomplete color image.

The mask may indicate a plurality of pixels which are not used for generating the second image, and the plurality of pixels may include a first plurality of pixels for which a depth is not indicated by the incomplete depth image, and a second plurality of pixels for which a depth indicated by the incomplete depth image is greater than a depth indicated by the depth map.

The original image may be captured by at least one of an augmented reality (AR) device and a virtual reality (VR) device, the original viewpoint may include a current viewpoint of a user, and the original image corresponds to a current AR/VR image displayed to the user, and the method further may include: obtaining a completed 3D representation of the scene based on the second image; obtaining a potential AR/VR image based on the completed 3D representation, wherein the potential AR/VR image corresponds to a potential viewpoint of the user; and based on the user moving from a position corresponding to the current viewpoint to a position corresponding to the potential viewpoint, displaying a transition between the current AR/VR image and the potential AR/VR image to the user.

The original image may be captured by a robot, and the method further may include planning a movement path for the robot based on the second image.

In accordance with an aspect of the disclosure, an electronic device for processing image data for scene completion includes: at least one memory configured to store instructions; and at least one processor configured to execute the instructions to: receive an original image from an original viewpoint corresponding to a first direction, wherein the original image includes an object and a background, wherein a first surface of the object is an image of the object corresponding to the first direction, obtain a first image from a new viewpoint corresponding to a second direction different from the first direction by rotating the original image based on 3-dimensional (3D) information generated based on 2-dimensional information which is obtained from the original image, determine an area within the first image for generating a second surface of the object based on depth information about a depth between the object and the background of the original image; and obtain a second image by inputting the first image and the determined area to an artificial intelligence (AI) inpainting model, wherein the AI inpainting model generates the second surface of the object which occupies a portion of the determined area in the second image.

The at least one processor may be further configured to execute the instructions to: render an incomplete color image and an incomplete depth image corresponding to the new viewpoint based on the 3D information, ask a portion of the incomplete color image based on the 3D information and the incomplete depth image to obtain a masked color image, wherein the masked portion of the incomplete color image corresponds to the determined area and indicates that the masked portion of the incomplete color image is obscured by the object when the scene is viewed from the new viewpoint, and inpaint the masked color image to obtain the second image.

To inpaint the masked color image, the at least one processor may be further configured to execute the instructions to: inpaint the masked color image based on the AI inpainting model to obtain the second image.

The at least one processor may be further configured to execute the instructions to: obtain an image caption by providing the second image to an AI caption model; and determine whether to re-inpaint the second image by comparing an embedding of the image caption and an embedding of the prompt.

The at least one processor may be further configured to execute the instructions to: mask a portion of the incomplete depth image based on the 3D information and the incomplete depth image to obtain a masked depth image, wherein the masked portion of the incomplete depth image corresponds to the determined area; provide the second image to an AI depth estimation model; generate an estimated depth image based on the masked depth image and an output of the AI depth estimation model; and generate a completed 3D representation based on the second image and the estimated depth image.

To generate the estimated depth image the at least one processor may be further configured to execute the instructions to: obtain at least one estimated normal and at least one estimated occlusion boundary by providing the second image to the AI depth estimation model; and obtain the estimated depth image based on the incomplete depth image, the at least one estimated normal, and the at least one estimated occlusion boundary.

The at least one processor may be further configured to execute the instructions to: render a plurality of incomplete color images and a plurality of incomplete depth images from a plurality of new viewpoints based on the 3D information; mask the plurality of incomplete color images to obtain a plurality of masked color images, and masking the plurality of incomplete depth images to obtain a plurality of masked depth images; obtain a plurality of second images by providing the plurality of masked color images to the AI inpainting model; provide the plurality of second images to the AI depth estimation model; and obtain a plurality of estimated depth images based on the plurality of masked depth images and a plurality of outputs of the AI depth estimation model; and the completed 3D representation is further generated based on the plurality of second images and the plurality of estimated depth images.

To generate the completed 3D representation, the at least one processor may be further configured to execute the instructions to: generate a plurality of estimated point clouds based on the second image, the estimated depth image, the plurality of second images, and the plurality of estimated depth images; and merge the plurality of estimated point clouds by discarding points which are not included in at least two estimated point clouds from among the plurality of estimated point clouds.

To mask the incomplete color image, the at least one processor may be further configured to execute the instructions to: generate a plurality of points which extend beyond a surface included in the original image; generate a mesh based on the plurality of points; render a depth map representing the mesh from the new viewpoint; generate a mask based on a comparison between the incomplete depth image and the depth map; and apply the mask to the incomplete color image.

The mask may indicate a plurality of pixels which are not used for generating the second image, and the plurality of pixels may include a first plurality of pixels for which a depth is not indicated by the incomplete depth image, and a second plurality of pixels for which a depth indicated by the incomplete depth image is greater than a depth indicated by the depth map.

The original image may be captured by at least one of an augmented reality (AR) device and a virtual reality (VR) device, wherein the original viewpoint may include a current viewpoint of a user, and the original image corresponds to a current AR/VR image displayed to the user, and wherein the at least one processor may be further configured to execute the instructions to: obtain a completed 3D representation of the scene based on the second image; obtain a potential AR/VR image based on the completed 3D representation, wherein the potential AR/VR image corresponds to a potential viewpoint of the user; and based on the user moving from a position corresponding to the current viewpoint to a position corresponding to the potential viewpoint, display a transition between the current AR/VR image and the potential AR/VR image to the user.

The original image may be captured by a robot, and the at least one processor may be further configured to execute the instructions to plan a movement path for the robot based on the estimated point cloud.

In accordance with an aspect of the disclosure, a non-transitory computer-readable medium is configured to store instructions which, when executed by at least one processor of a device for processing image data for scene completion, cause the at least one processor to: receive an original image from an original viewpoint corresponding to a first direction, wherein the original image includes an object and a background, wherein a first surface of the object is an image of the object corresponding to the first direction; obtaining a first image from a new viewpoint corresponding to a second direction different from the first direction by rotating the original image based on 3-dimensional (3D) information generated from 2-dimensional information about the scene which is obtained from the original image; determine an area within the first image for generating a second surface of the object based on depth information about a depth between the object and the background of the original image; and obtain a second image by inputting the first image and the determined area to an artificial intelligence (AI) inpainting model, wherein the AI inpainting model generates the second surface of the object which occupies a portion of the determined area in the second image.

The instructions may further cause the at least one processor to: render an incomplete color image and an incomplete depth image corresponding to the new viewpoint based on the 3D information; mask a portion of the incomplete color image based on the 3D information and the incomplete depth image to obtain a masked color image, wherein the masked portion of the incomplete color image corresponds to the determined area and indicates that the masked portion of the incomplete color image is obscured by the object when the scene is viewed from the new viewpoint; and inpaint the masked color image to obtain the second image.

The instructions may further cause the at least one processor to: inpaint the masked color image based on the AI inpainting model to obtain the second image.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram showing a viewpoint module, according to embodiments of the present disclosure;

FIG. 2 is a flowchart illustrating a method of processing an image to perform scene completion, according to embodiments of the present disclosure;

FIG. 3A is a diagram showing a scene completion system, according to embodiments of the present disclosure;

FIG. 3B is a diagram illustrating a process for generating a merged point cloud, according to embodiments of the present disclosure;

FIG. 4 is a diagram showing an example configuration of a surface-aware masking module, according to embodiments of the present disclosure;

FIG. 5 is a diagram showing an example of generating a mask without using surface-aware masking, according to embodiments of the present disclosure;

FIG. 6A to 6C illustrate results of performing scene completion based on a mask generated according to FIG. 5, according to embodiments of the present disclosure;

FIGS. 7A-7D are diagrams showing an examples of generating a mask using surface-aware masking, according to embodiments of the present disclosure;

FIG. 8A to 8C illustrate results of performing scene completion based on a mask generated according to FIGS. 7A-7D, according to embodiments of the present disclosure;

FIG. 9 is a flowchart illustrating a method of performing surface-aware masking for scene completion, according to embodiments of the present disclosure;

FIGS. 10A to 10C show further examples of a surface-aware masking process, according to embodiments of the present disclosure;

FIGS. 11A to 11C show further examples of a surface-aware masking process, according to embodiments of the present disclosure;

FIGS. 12A and 12B are flowcharts illustrating a use applications of scene completion methods, according to embodiments of the present disclosure;

FIGS. 13A and 13B are a flowchart illustrating a method of processing an image to perform scene completion, according to embodiments of the present disclosure;

FIG. 14 is a diagram of electronic devices for performing scene completion according to embodiments of the present disclosure; and

FIG. 15 is a diagram of components of one or more electronic devices of FIG. 12 according to embodiments of the present disclosure.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “module” is intended to be broadly construed as hardware, software, firmware, or any combination thereof.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

Embodiments may relate to methods, systems, and apparatuses for performing scene completion. Embodiments may provide a method, system, or apparatus which may receive an input image of a scene, for example an RGB-D image, and may generate a completed 3D representation of the scene, for example a completed scene point cloud, which may include regions which are unobservable or occluded in the input image. In embodiments, a point cloud may be a multidimensional set of points which represent at least one of an object and a space. For example, each point may represent geometric coordinates of a single point on a surface of an object, and may further represent information such as texture information and color information corresponding to the single point. In embodiments, the scene may include one or more objects and a background, and the completed scene point cloud may include both depth information and texture information about the scene and the one or more objects included and the background in the scene. Although examples are provided herein in terms of point clouds, embodiments are not limited thereto. For example, embodiments may relate to any multidimensional representations of objects and spaces, for example mesh representations, voxel grid representations, implicit surface representations, distance field representations, and any other type of representation.

According to some embodiments, the reconstruction of the completed scene point cloud may be performed in two general steps, for example a step of scene view completion, and a step of lifting the scene from a two dimensional representation to a three dimensional representation. For example, embodiments may apply the generalization capability of large language models to inpaint the missing areas of color images rendered from different viewpoints. Then, these inpainted images may be converted from two-dimensional (2D) images to three-dimensional (3D) representations, for example point clouds, by predicting per-pixel depth values using a combination of a trained network and depth information in the input image. In embodiments, this lifting process may be referred to as deprojection.

According to some embodiments, an entire completed scene point cloud for a scene may be reconstructed based on a single image of the scene, for example a single RGB-D image. For example, based on the single image, the entire scene layout may be reconstructed in a globally-consistent fashion. Some related-art methods may be confined to task-specific models which often do not generalize appropriately to distributions beyond the training data, which may limit their applicability. In contrast, embodiments of the present disclosure may provide generalization to unseen scenes, objects, and categories by leveraging inpainted features. Embodiments may utilize the generalizable aspects of machine learning (ML) and artificial intelligence (AI) models, for example visual language models (VLMs) for completing novel views and depth maps. The integrated pipeline provided by embodiments may be used for scene completion of unseen objects with occlusion and clutter.

For example, according to embodiments, the generalization capabilities of large VLMs with respect to 2D images may be leveraged to lift the information contained in the 2D images into 3D space for practical robotics applications. Accordingly, embodiments may provide consistent scene completion in new environments, and with unseen objects.

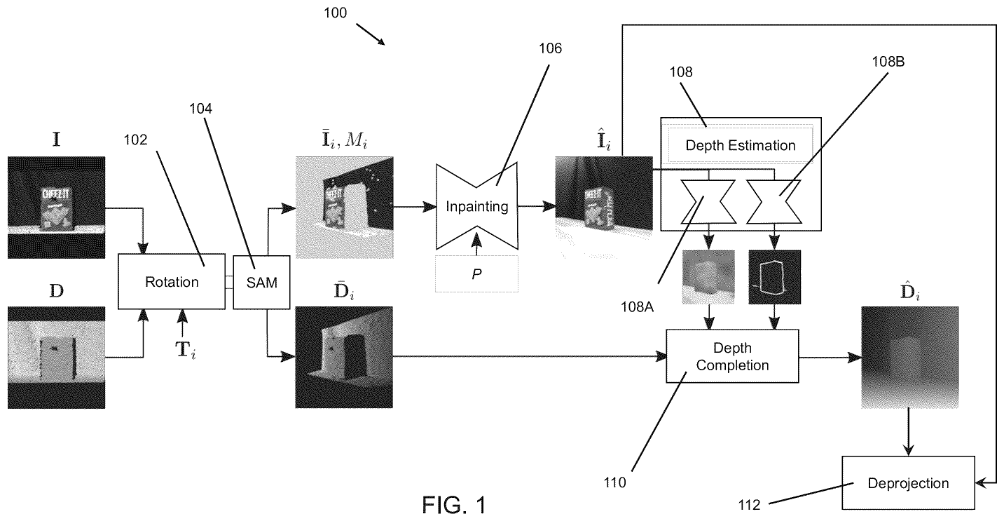

FIG. 1 is a diagram showing a viewpoint module for performing scene completion, according to embodiments of the present disclosure.

As shown in FIG. 1, a viewpoint module 100 may include an image rotation module 102, a surface-aware masking (SAM) module 104, an inpainting model 106, one or more depth estimation models 108, for example normal estimation model 108A and boundary estimation model 108B, a depth completion module 110, and a deprojection module 112.

According to embodiments, the viewpoint module 100 may receive an original image, for example an RGB-D image [symbol] ∈ [symbol] ^{H×W×4} of a scene, as input, and may output one or more estimated point clouds Ŝᵢ∈ [symbol] ^{N×3}, where N is the number of predicted points in the scene, and H and W denote dimensions of the RGB-D image. In embodiments, the RGB-D image [symbol] may include an input color image I and an input depth image D. In embodiments, a color image may be referred to as an RGB image or a texture image.

In some embodiments, the image rotation module 102, the SAM module 104, and the inpainting model 106 may be referred to as an inpainting pipeline, which may receive the RGB-D image [symbol] from an original viewpoint T₀, and may output an incomplete depth image D̅ᵢ and an inpainted color image Îᵢ from a new viewpoint Tᵢ. For example, in some embodiments, the original viewpoint T₀ may correspond to a view of the scene from a first direction, and the new viewpoint Tᵢ may correspond to a view of the scene from a second direction which is different from the first direction. The one or more depth estimation models 108 and the depth completion module 110 may be referred to as a depth completion pipeline, which may receive the incomplete depth image D̅ᵢ and the inpainted color image Îᵢ, and may output an estimated depth image \hat{D}ᵢ.

The deprojection module 112 may generate 3D information about the scene based on 2D information which is obtained from the RGB-D image [symbol] . In embodiments, the 2D information may include at least one from among boundary information, texture information, color information, and depth information included in the RGB-D image [symbol] . In embodiments, the 3D information may include a 3D representation of the scene, for example a point cloud as discussed above. In some embodiments, the deprojection module 112 may receive the inpainted color image Îᵢ and the estimated depth image \hat{D}ᵢ, and may obtain an estimated point cloud Si corresponding to the viewpoint Tᵢ.

For example, a process of generating a 2D image from a 3D representation, such as a point cloud, may be referred to as projecting the 2D image from the point cloud. Similarly, a process of generating a 3D representation such as a point cloud from a 2D image may be referred to as deprojecting the point cloud from the 3D image. For example, given a depth image which is a 2D image that has a depth value at every pixel, and also given camera information used to capture the 2D image (for example focal length, etc.), it may be possible to deproject each pixel using the camera information and the depth information at that 2D pixel location. In embodiments, this may be similar to drawing a line or ray from the camera through the 2D pixel location, and placing a point along the line at a distance corresponding to the depth information for the pixel. If the depth image is available, then the deprojection may be performed without an algorithm or model. However, if no depth image is available, or only a partial depth image is available, an AI model such as the one or more depth estimation models 108 may be used to predict the depth image.

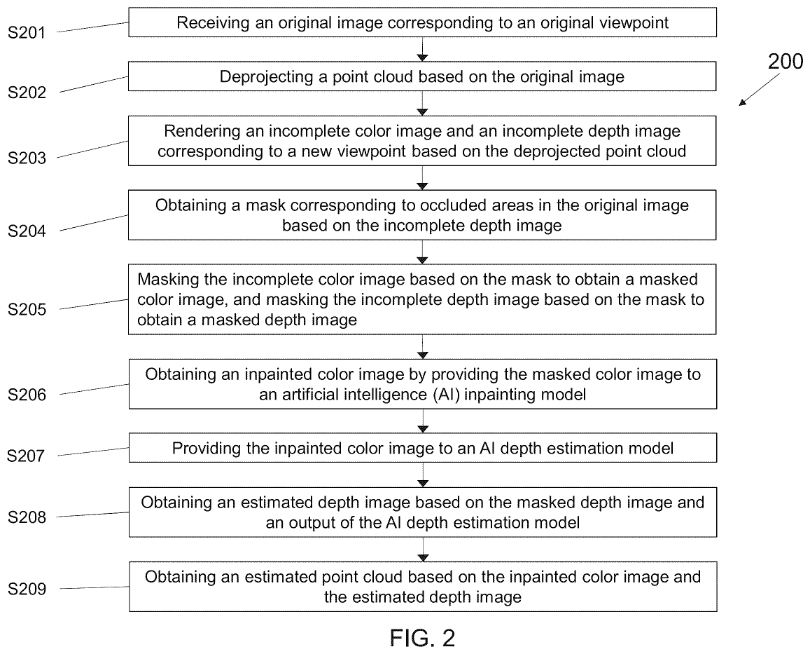

FIG. 2 is a flowchart illustrating a method 200 of processing an image to perform scene completion, according to embodiments of the present disclosure. In embodiments, one or more operations of the method 200 of FIG. 2 may be performed by or using the viewpoint module 100 and any of the elements included therein, and any other element described herein.

Referring to FIG. 2, at operation S201 the image rotation module 102 may receive the RGB-D image [symbol] and information about the image [symbol] , for example intrinsic information about a camera or other device used to capture the image [symbol] (such as focal length, etc). Then, at operation S202, the image rotation module 102 may deproject the image [symbol] into a point cloud S₀ corresponding to the original viewpoint T₀. At operation S203, the image rotation module 102 may then rotate the deprojected point cloud S₀ by an angle θ about its center point, and the rotated point cloud may be reprojected to render an incomplete color image Īᵢ and an incomplete depth image D̅ᵢ. In embodiments, the incomplete color image Īᵢ and an incomplete depth image D̅ᵢ may be referred to as “incomplete” because they may be missing information about one or more areas of the scene which are obscured or occluded by an object in the deprojected point cloud S₀. For example, when the point cloud S₀ is rotated, some points in the rotated point cloud may correspond to occluded areas of the scene which are obscured by a surface of an object which is present in the RGB-D image [symbol] . For example, the occluded areas of the scene may be regions which include at least one of a portion of a background of the original image (from the new viewpoint Tᵢ), and a portion of a surface of an object (from the new viewpoint Tᵢ). In embodiments, this portion of the surface of the object may be referred to as an “object area”. Therefore, when the rotated point cloud is used to generate a 2D image, this 2D may also be missing information, and therefore may be referred to as an incomplete image. Because the rotation of the point cloud S₀ may correspond to changing the viewpoint, the incomplete color image Īᵢ and the incomplete depth image D̅ᵢ may correspond to a new viewpoint Tᵢ. In embodiments, the incomplete color image Īᵢ and the incomplete depth image D̅ᵢ may be missing color information and depth information corresponding to areas of the scene which are occluded or otherwise not visible in the original RGB-D image [symbol] . In embodiments, the incomplete color image Īᵢ and the incomplete depth image D̅ᵢ may be referred to as, or included in, an incomplete RGB-D image [symbol] .

In embodiments, a process for generating the incomplete RGB-D image [symbol] from the new viewpoint Tᵢ based on information in the original image [symbol] may be referred to as “rotating” the original image [symbol] . For example, the process of deprojecting the image [symbol] into the point cloud S₀, rotating the deprojected point cloud S₀, and reprojecting to render the incomplete color image Īᵢ and the incomplete depth image D̅ᵢ described above with respect to operations S202 and S203 may be referred to as “rotating” the original image 3.

In embodiments, the new viewpoint Tᵢ may be selected based on a context ratio C, which may be determined based on Equation 1 below:

$$C = {P}_{C} / {P}_{A} \qquad Equation 2$$

In Equation 1 above, P_{C} may denote a number of context pixels in an image, and P_{A} may denote a number of all pixels in an image. The context ratio C may provide an indication about how accurately an inpainting model such as the inpainting model 106 may be able to fill in missing areas in an image. For example, a low value of the context ratio C may indicate that many areas are unknown, and that an inpainting model may struggle to fill in missing areas, and a high value of the context ratio C may indicate that an inpainting model may more easily fill in missing areas, but may only fill in limited information.

When selecting the new viewpoint Tᵢ, the image rotation module 102 may start from the original viewpoint T₀, and may rotate the deprojected point cloud S₀ in various directions to various new viewpoints. At each step in the rotation, an image may be projected based on the rotated point cloud, and a context ratio C of the projected image may be calculated. Based on the context ratio C of a projected image satisfying a predetermined criteria, the corresponding viewpoint may be selected as the new viewpoint Tᵢ. In some embodiments, the predetermined criteria may be satisfied when the context ratio C of a projected image being closest to context threshold C* from among context ratios a plurality of projected images corresponding to a plurality of new viewpoints. This process may be repeated to obtain a plurality of evenly spaced new viewpoints, but embodiments are not limited thereto.

In some embodiments, before the incomplete color image Īᵢ is inpainted, preprocessing steps may be applied to increase the quality of the inpainting results. For example, the incomplete color image Īᵢ may be preprocessed to fill in relatively small holes which are produced as a result of the reprojecting described above. For example, a naive inpainting filter that works with relatively small areas of missing values may be applied. In embodiments, the naive inpainting filter may be a general inpainting filter or inpainting model which is trained using a general image dataset that is not specific to the particular scene. Starting at boundaries of missing pixels, a weighted average of the nearest ground truth pixels may be determined. The naive inpainting filter may then work inward to fill larger holes. In embodiments, the naive inpainting filter may be used to fill relatively small holes of missing information in order to produce a denser image that gives more context for the inpainting model 106. However, the naive inpainting filter may produce unrealistic results for relatively large missing areas.

Therefore, at operation S204, the SAM module 104 may generate a mask Mᵢ which indicates the large missing areas. In general, the missing areas may include areas in which no pixel information is available when the original image is rotated. Further, even if there is pixel information available when the original image is rotated (some of which may correspond to the background) the SAM module 104 may determine that an area predicted as the surface area of the object should be masked. An example of a method for generating the mask is provided below with respect to FIGS. 4 to 9C. At operation S205, the SAM module 104 may mask the incomplete color image Īᵢ to obtain a masked color image, and may mask the incomplete depth image D̅ᵢ to obtain a masked depth image.

At operation S206, the viewpoint module 100 may provide the masked color image, or for example the mask Mᵢ and the incomplete color image Īᵢ, to the inpainting model 106 to obtain an inpainted color image Îᵢ. For example, the inpainting model 106 may generate predicted image information corresponding to portions of the incomplete color image Īᵢ which are masked by the mask Mᵢ, and the inpainted color image Îᵢ may be generated by applying the predicted image information to the incomplete color image Īᵢ. In some embodiments, the inpainted color image Îᵢ may be referred to as a predicted image. In embodiments, the inpainting model 106 may be or may include an AI or ML model, for example at least one of a diffusion model and a VLM such as DALL-E 2.

In some embodiments, the inpainting model 106 may receive the masked color image and an input prompt P that describes the context of the original RGB-D image [symbol] in words or text. For example, based on the original scene including objects on a tabletop, the prompt P may include “household objects on a table”. As another example, based on the original scene including a room to be vacuumed by a robotic vacuum cleaner, the prompt P may include “room with carpet and furniture”. As further examples, the prompt P may include any additional known information about the scene, such as “a baseball and glove on a table” if these objects are known to be on the table, or “top-down view of household objects on a table” if the viewpoint is known to be from a top-down perspective. For example, the additional known information may be at least one of information that was previously provided or confirmed by a user, information that is associated with the image such as information included in tags or metadata, and information obtained using image analysis or view analysis, for example using an image analysis algorithm or model. However, embodiments are not limited thereto, and the prompt P may include any other information. For example, in some embodiments the original RGB-D image [symbol] may be provided to an automatic captioning model, and the output of the output of the automatic captioning model may be used as the prompt P. In detail, based on the scene including objects on a tabletop, the output of the automatic captioning model may be a proposed prompt such as “household objects on a table”. This output may be provided to the user, and the user may then revise or modify this proposed prompt to obtain a revised prompt. Based on the example above, the revised prompt may be “household objects such as a dish, cloth, cutlery, and a pot on a table”, or “household objects such as drinking glasses and dinner plates on a white marble dining table” (in which text in italics indicates modifications to the proposed prompt which are input by the user).

As another example, the user may input an original prompt P, and then based on the output of the inpainting model 106, may modify the original prompt P to obtain a revised prompt, and may request a new inpainted image to be generated based on the revised prompt. For example, the user may originally input “a baseball and glove on a table” as the original prompt P. After reviewing the inpainted image output by the inpainting model 106, the user may input a revised prompt such as “a baseball and a leather baseball glove on a wooden table” (in which text in italics indicates revisions to the original prompt P which are input by the user).

As another example, a user may input any prompt as desired, for example to change the style of the original RGB-D image [symbol] to another style. For example, the appearance or visual style of the original RGB-D image [symbol] may be modified using a neural style transfer (NST) model, for example by modifying style features of the original RGB-D image [symbol] while maintaining content features of the original RGB-D image [symbol] .

The inpainting model 106 may output the inpainted color image Îᵢ, which may contain estimated areas corresponding to areas of the incomplete color image Īᵢ which are masked by the mask Mᵢ.

The term “prompt” may refer to text used to initiate interaction with a generative model that generates images for electronic devices. A prompt may include one or more words, phrases, and/or sentences. In embodiments, the inpainting model 106 may be, may include, or may be similar to such a generative model. In one example, a prompt may contain natural language text that carries various information that the generative model can use to generate images, such as context, intent, task, constraints, and more. Electronic devices may process natural language text using natural language processing (NLP) models.

In one scenario, prompts and revised prompts can be received from users. For instance, electronic devices may receive text input from users, or they can receive voice input and perform automatic speech recognition (ASR) to convert the user's voice input into text.

In another example, prompts may be generated by electronic devices using various techniques, such as image captioning. For instance, electronic devices can receive image input from users and extract text descriptions from the images.

Additionally, the term “prompt” may be replaced with a similar expression that represents the same concept. For example, prompts can be replaced with terms like “input.” “user input,” “input phrase,” “user command,” “directive.” “starting sentence,” “task query,” “trigger sentence,” “message,” and others, not limited to the examples mentioned.

Due to the randomized nature of inpainting, some inpainted color images Îᵢ which may be generated by the inpainting model 106 may vary in terms of their perceived realism. Therefore, in some embodiments, the inpainting model 106 may be used to generate multiple candidate inpainted color images based on the same masked color image. Then, these candidate inpainted color images may be compared against the input prompt P by encoding them to an embedded space, and the candidate inpainted color image having the highest similarity may be chosen as the inpainted color image Îᵢ.

At operation S207, the inpainted color image Îᵢ may be provided to one or more depth estimation models 108. In embodiments, the one or more depth estimation models 108 may be ML or AI models. For example, the inpainted color image Îᵢ may be provided to the normal estimation model 108A, which may be trained to estimate normals, and the inpainted color image Îᵢ may be provided to the boundary estimation model 108B, which may be trained to estimate occlusion boundaries. In embodiments, the one or more depth estimation models 108 may be trained or optimized for a specific category of scenes, for example a scene including objects on a tabletop, or a scene including a room to vacuumed by a robotic vacuum cleaner. In embodiments, the estimated normals may be, for example, geometric normals. The term “normal” or “geometric normal” may refer to a vector associated with a point on a surface of a 3D object in computer graphics and 3D computer modeling, and may represent a direction in which a surface is facing at each point on the surface (i.e., the direction that is perpendicular to a tangent plane of the surface at that point).

At operation S208, the depth completion module 110 may generate an estimated depth image \hat{D}ᵢ based on the masked depth image and the output of the one or more depth estimation models. For example, depth information for areas with missing depths in the masked depth image may be computed by tracing along the estimated normals from areas of known depth, and the estimated occlusion boundaries may act as barriers which normals should not be traced across. As an example, in some embodiments a system of equations may be solved to minimize an error E, where E is defined according to Equation 2 below:

$$E = {λ}_{D} {E}_{D} + {λ}_{S} {E}_{S} + {λ}_{N} {E}_{N} B \qquad Equation 2$$

In Equation 2 above, E_{D} may denote the distance between the ground truth and estimated depth, E_{S} may denote the influences of nearby pixels to have similar depths, and E_{N} may denote the consistency of estimated depth and estimated normal values. In addition, λ_{D}, λ_{S}, and λ_{N} may denote constants or weight values corresponding to E_{D}, E_{S}, and E_{N}, respectively. Further, B may denote a weight value corresponding to the estimated normal vales based on the probability that a boundary is present. In embodiments, the value of B may be obtained based on the estimated occlusion boundaries discussed above.

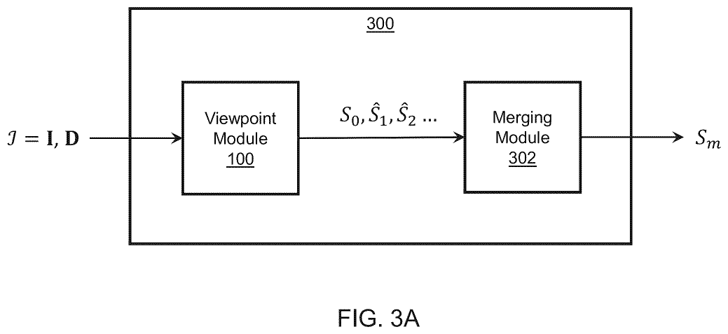

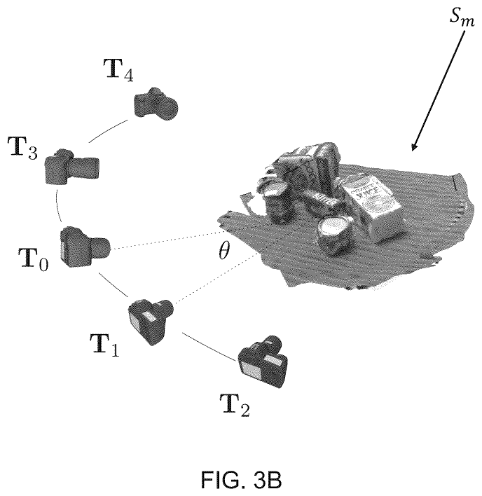

At operation S209, the deprojection module 112 may generate an estimated point cloud Ŝᵢ corresponding to the viewpoint Tᵢ by deprojecting the inpainted color image Îᵢ and the estimated depth image \hat{D}ᵢ. In some embodiments, the estimated point cloud Ŝᵢ may be a completed scene point cloud, and may be used to perform other tasks such as robot action planning, autonomous navigation, and image generation for AR devices and VR devices. In other embodiments, the method 200 may be performed multiple times based on multiple new viewpoints, and the resulting estimated point clouds may be merged to obtain the completed scene point cloud. An example of a merging process is described below with reference to FIGS. 3A-3B.

FIG. 3A is a diagram showing a scene completion system, and FIG. 3B is a diagram illustrating a process for generating a merged point cloud, according to embodiments of the present disclosure. According to embodiments, a scene completion system 300 may include the viewpoint module 100 discussed above, and a merging module 302. The scene completion system 300 may receive the RGB-D image [symbol] as input, and may output a completed scene point cloud which is obtained based on multiple estimated point clouds.

For example, the method 200 discussed above may be performed on the original RGB-D image [symbol] by rotating the point cloud S₀ by angle θ, to obtain estimated point cloud Ŝ₁ corresponding to a viewpoint T₁. Then, the method 200 may be performed again, this time rotating the point cloud S₀ by angle 2×θ to obtain estimated point cloud Ŝ₂ corresponding to a viewpoint T₂. The method 200 may then be performed two more times by rotating the point cloud S₀ by −θ and 2×−θ to obtain estimated point cloud Ŝ₃ corresponding to a viewpoint 73, and estimated point cloud Ŝ₄ corresponding to a viewpoint T₄. Accordingly, as shown in FIG. 3A, four novel views of the scene are obtained, complete with RGB and depth information.

The merging module 302 may combine the estimated point clouds Ŝ₁. Ŝ₂, Ŝ₃, and Ŝ₄ while enforcing consistency across them. For example, when inpainting real objects, completion of objects may be inconsistent, and hallucinated objects that are not in the original scene may be created by the inpainting model 106 and included in the inpainted color image Îᵢ.

To combat this issue, filtering may be performed for consistent predictions across viewpoints. For example, the merging module 302 may compare the original point cloud S₀ and at least one of the estimated point clouds Ŝ₁, Ŝ₂, Ŝ₃, and Ŝ₄, may determine points which intersect among multiple point clouds, and may add the intersecting points to the merged point cloud Sₘ, while discarding points which are present in only one point cloud. However, embodiments are not limited thereto. For example, in some embodiments the merged point cloud Sₘ may only include points which are present in more than two point clouds, or points which are present in all of the point clouds. As another example, the merging module 302 may discard points which do not directly intersect, or may only discard points which are not within a certain threshold distance from points in other point clouds.

In embodiments, the merged point cloud Sₘ may be a completed scene point cloud, and may be used to perform other tasks such as robot action planning, autonomous navigation, and image generation for AR devices and VR devices.

Although some embodiments are described above as generating a completed scene point cloud based on a single RGB-D image [symbol] , embodiments are not limited thereto. For example, the method 200 may be performed multiple times based on multiple RGB-D images, and the resulting estimated point clouds may be merged to generate the completed scene point cloud. As another example, the point cloud S₀ may be determined by deprojecting multiple RGB-D images, and the other steps of the method 200 may be performed based on the point cloud S₀. As yet another example, after the completed scene point cloud is generated, one or more additional or updated RGB-D images may be obtained, the method 200 may be performed based on the one or more additional or updated RGB-D images, and the resulting estimated point clouds may be merged with the previously-completed scene point cloud to obtain an updated point cloud.

FIG. 4 is a diagram showing an example configuration of the SAM module 104, according to embodiments of the present disclosure.

As shown in FIG. 4, the SAM module 104 may include a mask generation module 402, and an image masking module 404. As discussed above, after the original point cloud S₀ is rotated to the new viewpoint Tᵢ, any 3D space for which reconstruction is possible may be represented as being available for inpainting in the incomplete color image Īᵢ. In order to do so, the mask generation module 402 may generate the mask Mᵢ, which may indicate areas to be inpainted by the inpainting model 106.

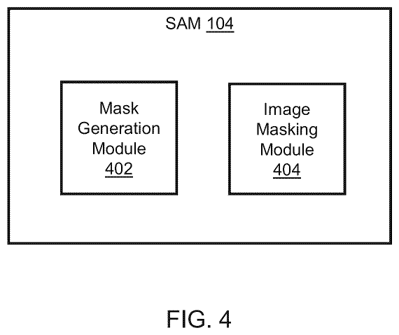

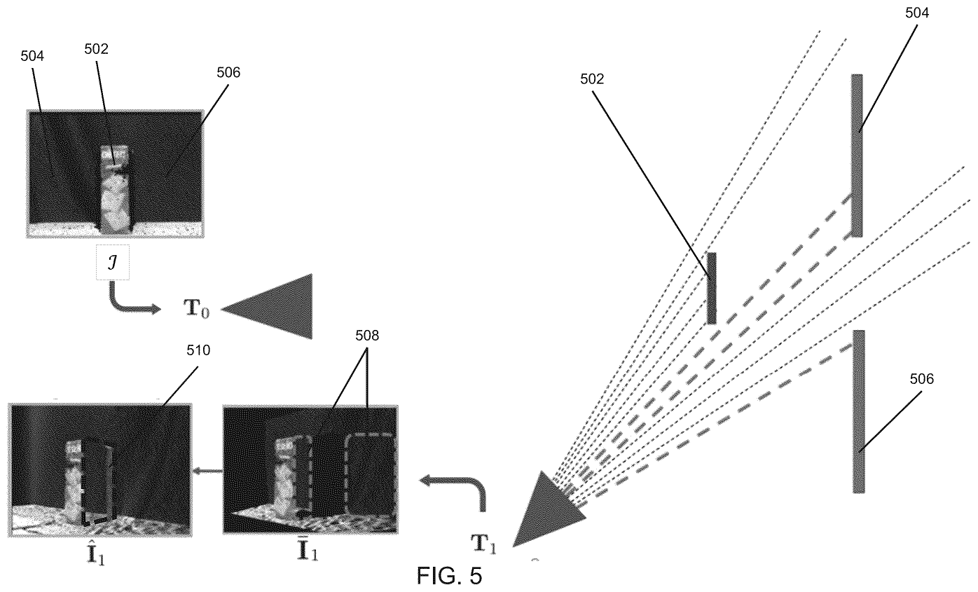

However, if a mask is generated without taking into account surfaces shown in the original RGB-D image [symbol] , the inpainting model 106 may inadvertently use background pixels to perform when performing inpainting on an occluded surface of an object. For example, as shown in FIG. 5, an original RGB-D image [symbol] may show a surface 502 of a foreground object, and background surfaces 504 and 506. When the point cloud S₀ is rotated to new viewpoint T₁, some inappropriate background pixels 508 from the background surfaces 504 and 506, which would not actually be visible from the viewpoint T₁, may be inadvertently included in the incomplete color image Ī₁, and may therefore be mistakenly used by the inpainting model 106 to perform inpainting corresponding to the object. For example, an image of a surface 510 in the inpainted color image Î₁ may be generated based on the inappropriate background pixels.

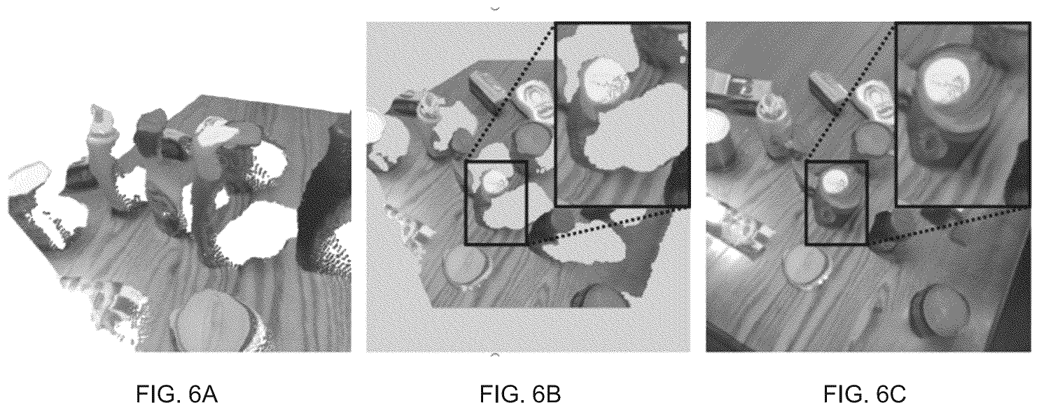

FIG. 6A shows an example of an incomplete color image Īᵢ that shows background pixels which are inappropriately included in areas which would be covered by objects. FIG. 6B shows a mask generated based on the incomplete color image Īᵢ of FIG. 6A, and FIG. 6C shows an example inpainted color image Îᵢ in which the inappropriate background pixels were used for inpainting.

Therefore, in order to prevent inappropriate pixels from being included in the incomplete color image Īᵢ, the SAM module 104 may perform surface-aware masking. For example, the mask generation module 402 may generate a 3D mesh, which may for example have a shape of a frustum, based on the input color image I and an input depth image D, and may use this 3D mesh to generate the mask Mᵢ.

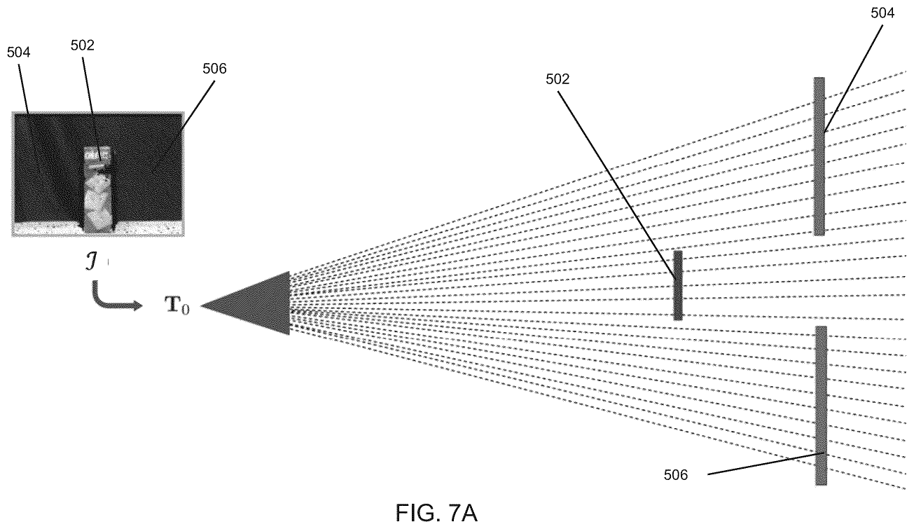

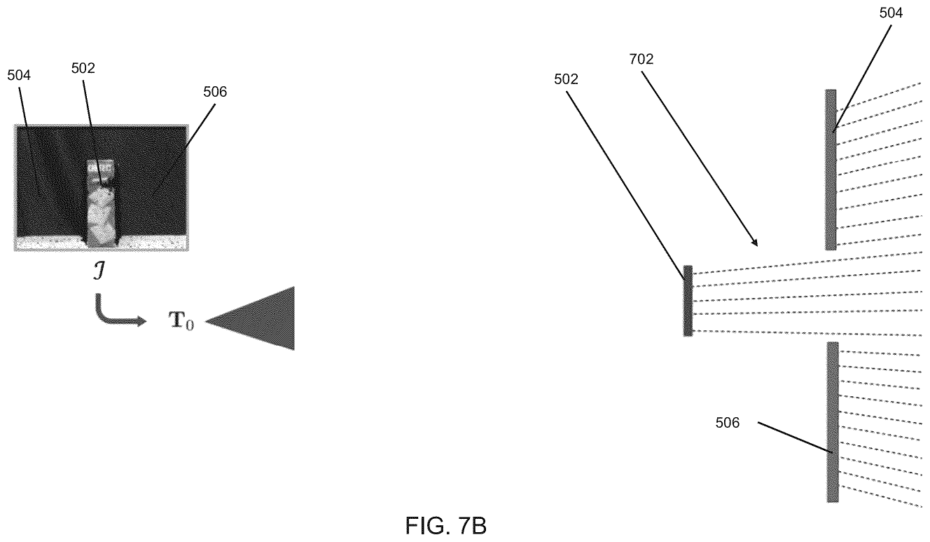

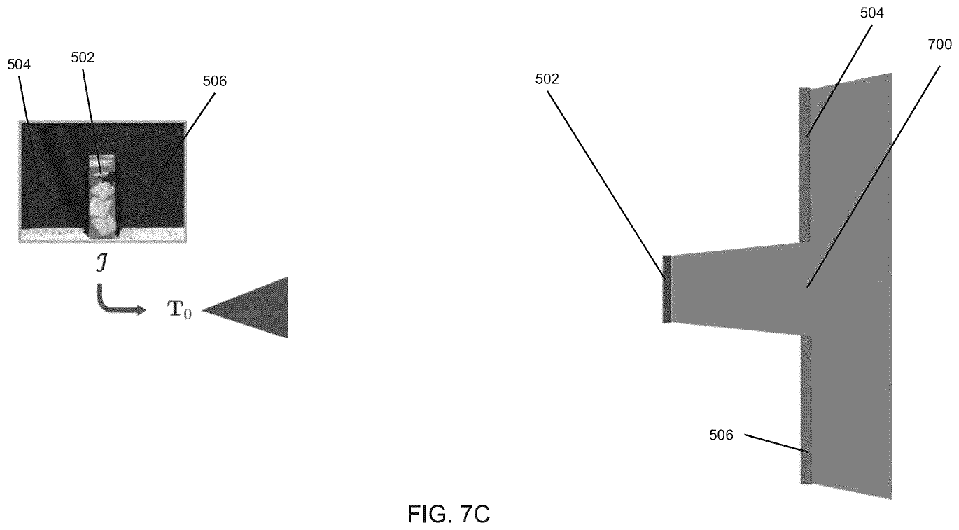

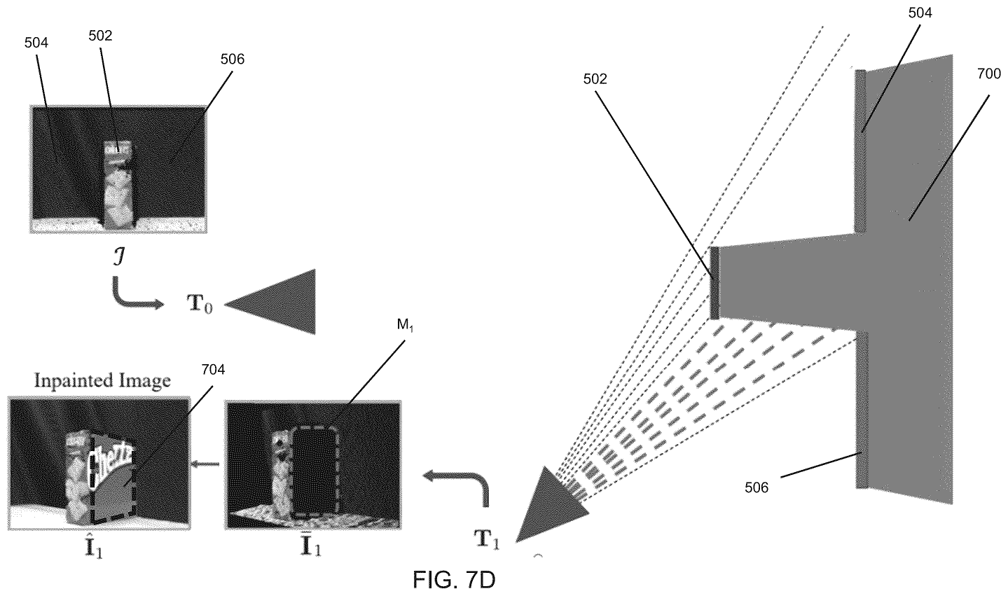

FIGS. 7A-7D show example operations which may be included in a surface-aware masking process, according to embodiments of the present disclosure.

As shown in FIG. 7A, for every pixel in the input color image I and the input depth image D, a ray may be cast from the viewpoint Tₒ through each point in the deprojected point cloud S₀. Once the ray has passed through its respective point, for example by passing through one of the surfaces 502, 504, and 506, it may be used to generate a list of points along the ray from that depth onward. As shown in FIG. 7B, the mask generation module 402 may perform this process for every ray to obtain an occlusion point cloud 702 which shows the potential space that could be possibly filled in the completed scene point cloud by objects corresponding to the surfaces. As shown in FIG. 7C, the mask generation module 402 may convert this occlusion point cloud to the mesh 700, and when the point cloud S₀ is rotated to the new viewpoint T₁, the mesh 700 may be rotated as well, as shown in FIG. 7D. Then, when the SAM module 104 projects the incomplete color image Ī₁ and the incomplete depth image D̅₁ from the rotated point cloud, the SAM module 104 may discard points which are occluded by the mesh 700. Accordingly, the incomplete color image Ī₁ may be prevented from including inappropriate pixels, as shown by the dashed boxes in FIG. 7D. For example, as can be seen in FIG. 7D the incomplete color image Ī₁ does not include the inappropriate background pixels 506 shown in FIG. 5. After these pixels are discarded, the blank pixels in the incomplete color image Ī₁ and the incomplete depth image D̅₁ may be used as the mask M₁. Based on the mask M₁, an inpainted color image Î₁ may be generated to include, for example, an image of a surface 704 in which the inappropriate background pixels are not included.

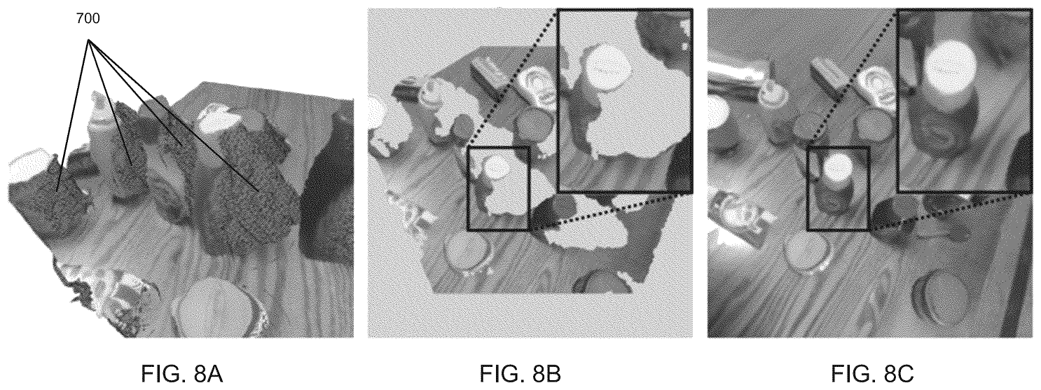

FIG. 8A shows an example of an incomplete color image Īᵢ in which surface aware masking is performed according to the process described above with respect to FIGS. 7A to 7D. As can be seen in FIG. 8A, the mesh 700 may prevent inappropriate pixels from being included in the incomplete color image Īᵢ. FIG. 8B shows a mask generated based on the incomplete color image Īᵢ of FIG. 8A, and FIG. 8C shows an example inpainted color image Îᵢ in which the inappropriate background pixels are not included.

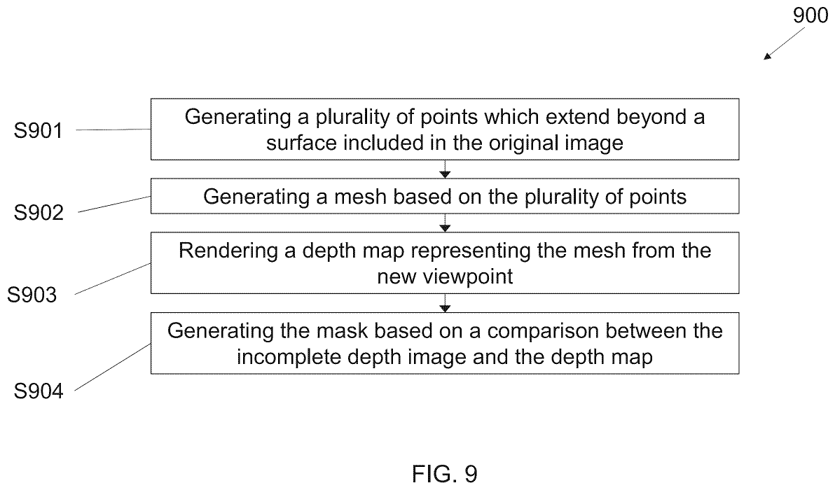

FIG. 9 is a flowchart illustrating a method 900 of performing surface-aware masking, according to embodiments of the present disclosure. In embodiments, one or more operations of the method 900 may correspond to the surface-aware masking process discussed above with respect to FIGS. 7A-7D.

As shown in FIG. 9, at operation S901 the mask generation module 402 may generate a plurality of points which extend beyond a surface included in the original RGB-D image [symbol] . For example, the mask generation module 402 may subsample pixels from a uniform grid in the input RGB-D image [symbol] to obtain a set of points U. Then, the mask generation module 402 may initialize an empty point set X, and for every point u in U, may deproject the point u to a point x in the point cloud S₀; and generate additional points which are then added to the point set X. In embodiments, the mask generation module 402 may add a predetermined number of additional points for each point u, and the additional points may be equally spaced. In embodiments, the number of additional points and the spacing therebetween may vary based on the scene. For example, based on the scene including objects on a tabletop, the mask generation module 402 may use fewer points which are more closely spaced than would be used for scene including a room to be vacuumed by a robot vacuum cleaner. However, embodiments are not limited thereto, and the number of additional points and the spacing therebetween may be determined in any manner. In embodiments, the point set X may correspond to the points shown in FIG. 7B.

Referring again to FIG. 9, at operation S902, the mask generation module 402 may generate a mesh based on the plurality of points. For example, the mesh may be generated by performing surface triangulation on the points in the point set X. In embodiments, this mesh may correspond to the mesh 700 discussed above.

Then, as discussed above, the method 900 may include discarding points which are occluded by the mesh. For example, at operation S903, the mask generation module 402 may render a depth map representing the mesh from the new viewpoint Tᵢ. Then, at operation S904, based on a comparison between the incomplete depth image D̅ᵢ and the depth map, the mask generation module 402 may generate the mask Mᵢ. For example, the mask generation module 402 may initialize all pixels of the mask Mᵢ as zeros (“0”s). Then, for each pixel in the mask Mᵢ, the mask generation module 402 may set the pixel to one (“1”) if the estimated depth for the pixel in the incomplete depth image D̅ᵢ is equal to zero (“0”) or is otherwise not present, or if the estimated depth for the pixel in the incomplete depth image D̅ᵢ is greater than the depth indicated for the pixel by the depth map representing the mesh. In the final mask Mᵢ, the pixels which are set to one (“1”) may correspond to the masked areas and/or the points which are discarded when generating the masked color image and the masked depth image.

For example, in some embodiments, if the incomplete depth image D̅ᵢ includes an estimated depth for a particular pixel that is greater than the depth indicated for that same pixel by the depth map, this may indicate that the pixel corresponds to an area of the scene that was occluded or obscured in the original RGB-D image [symbol] by a surface corresponding to the mesh. Accordingly, information corresponding to that pixel in the incomplete depth image D̅ᵢ and in the incomplete color image Īᵢ may be determined to be unreliable, and the pixel may therefore be masked and/or discarded when the masked color image and the masked depth image are generated.

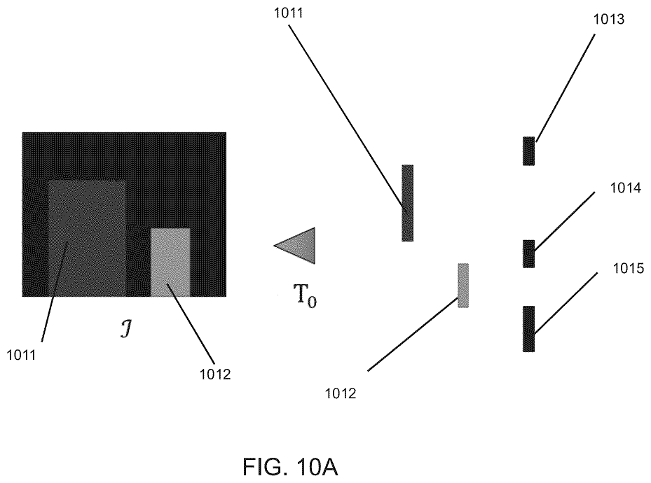

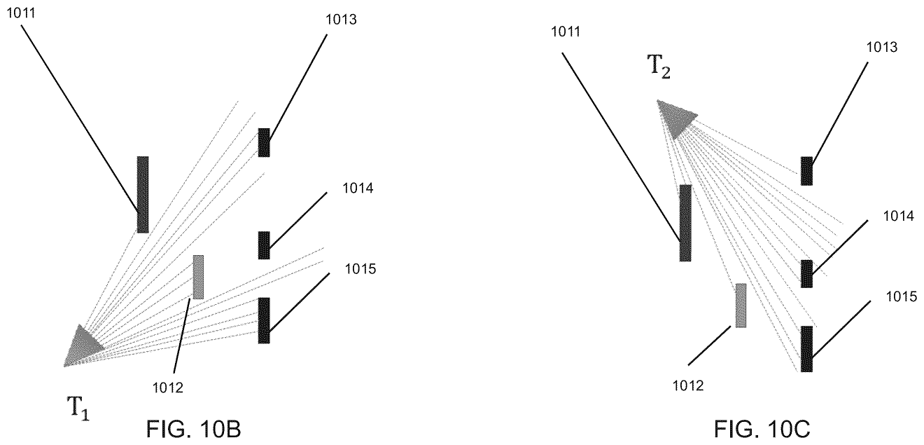

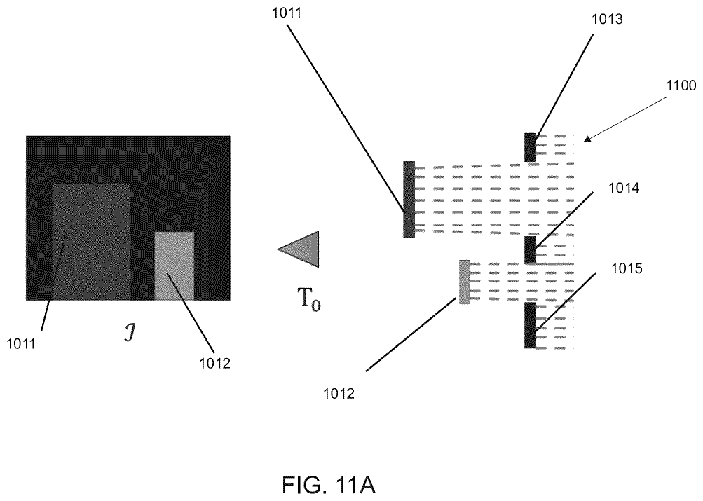

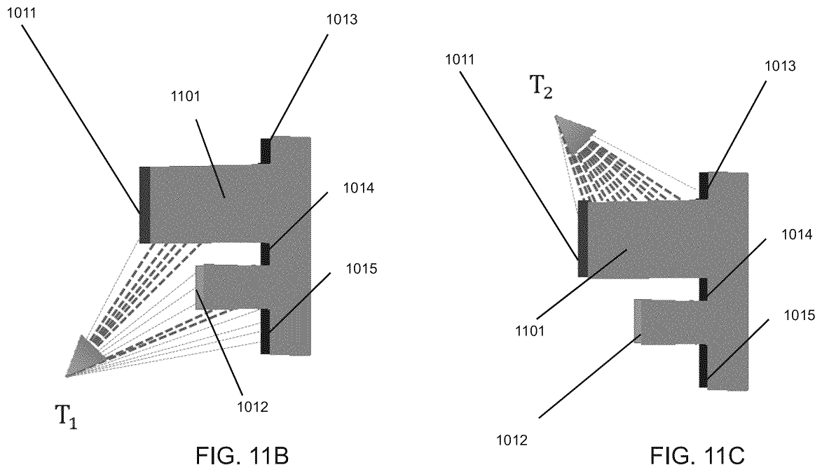

FIGS. 10A-10C and FIGS. 11A-11C show further examples of a surface-aware masking process, according to embodiments of the present disclosure.

As shown in FIG. 10A, similar to FIG. 5 above, an original RGB-D image [symbol] may show a surface 1011 of a first foreground object and a surface 1012, and background surfaces 1013 and 1014. When the point cloud S₀ is rotated to new viewpoint T₁ and T₂ as shown in FIGS. 10B and 10C, some inappropriate background pixels from the background surfaces 1013 and 1014, which would not actually be visible from the viewpoints T₁ and T₂, may be inadvertently included in the incomplete color images Ī₁ and Ī₂, and may therefore be mistakenly used by the inpainting model 106 to perform inpainting corresponding to the object.

Therefore, as shown in FIG. 11A, for every pixel in the input color image I and the input depth image D, a ray may be cast from the viewpoint Tₒ through each point in the deprojected point cloud S₀. Once the ray has passed through its respective point, for example by passing through one of the surfaces 1011, 1012, 1013, 1014, and 1014, it may be used to generate a list of points along the ray from that depth onward. The mask generation module 402 may perform this process for every ray to obtain an occlusion point cloud 1100 which shows the potential space that could be possibly filled in the completed scene point cloud by objects corresponding to the surfaces. As shown in FIGS. 11B and 11C, the mask generation module 402 may convert this occlusion point cloud to the mesh 1101, and when the point cloud S₀ is rotated to the new viewpoints T₁ and T₂, the mesh 1101 may be rotated as well. Then, when the SAM module 104 projects the incomplete color image Ī₁ and the incomplete depth image D̅₁ from the rotated point cloud, the SAM module 104 may discard points which are occluded by the mesh 1101. Accordingly, the incomplete color image Ī₁ may be prevented from including inappropriate pixels.

Although embodiments discussed above show that the mask Mᵢ is obtained after the incomplete color image Īᵢ and the incomplete depth image D̅ᵢ, embodiments are not limited thereto. For example, in some embodiments, the mesh 700 and the mask Mᵢ corresponding to the new viewpoint Tᵢ may be generated based on depth information included in the original image [symbol] , and then the incomplete color image Īᵢ and the incomplete depth image D̅ᵢ may be generated, for example by rotating and reprojecting the deprojected point cloud S₀.

Embodiments described above may be useful in many different use applications. For example, embodiments described above may be used by at least one of an AR device and a VR device to perform scene completion of an environment surrounding a user in order to generate appropriate AR and VR images in anticipation of movements by the user. For example, during a time period in which the user is stationary, embodiments described above may be used to perform scene completion to reconstruct areas which are not immediately visible to the user, but which the user may wish to see later. The completed scene point cloud may then be used to construct a plurality of potential AR/VR images to be displayed to the user, which may help to reduce latency in images provided to the user. Accordingly, images displayed by the AR device or the VR device may seamlessly transition according to a user's head movements.

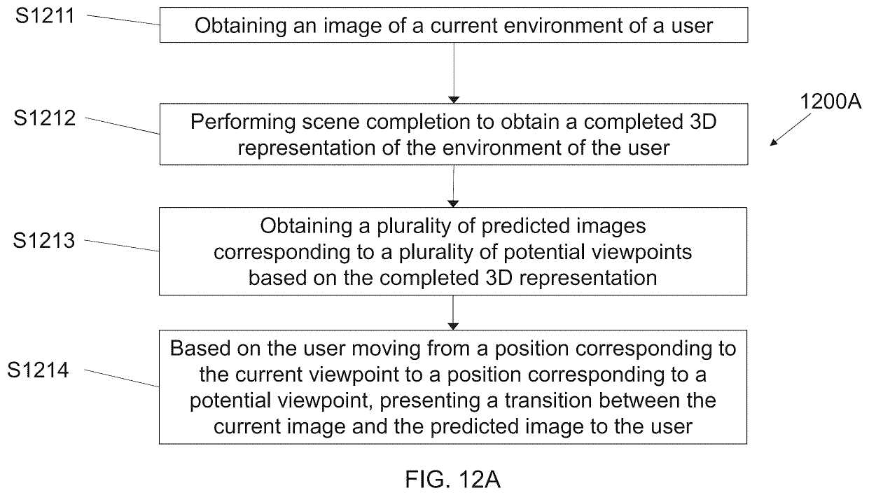

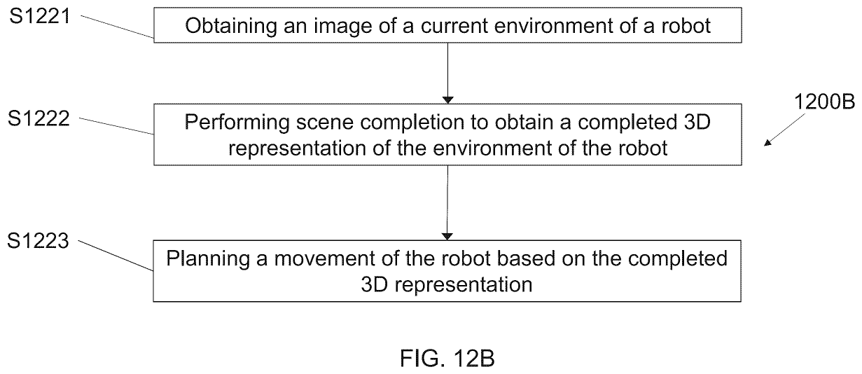

FIG. 12A is a flowchart illustrating a method 1200A of performing scene completion in at least one of an AR device and a VR device, according to embodiments of the present disclosure. In embodiments, one or more operations of the method 1200A may be performed by or using at least one of the viewpoint module 120, the scene completion system 300, and any of the elements included therein, and any other element described herein.

As shown in FIG. 12A, at operation S1211, the method 1200A may include obtaining an image corresponding to a current viewpoint of a user. In embodiments, the image may correspond to the original RGB-D depth image [symbol] described above.

As further shown in FIG. 12A, at operation S1212, the method 1200A may include performing scene completion to obtain a completed 3D representation of the environment of the user, for example a completed scene point cloud of a scene included in the environment. In embodiments, the scene completion may correspond to any of the scene completion methods described above.

As further shown in FIG. 12A, at operation S1213, the method 1200A may include obtaining a plurality of potential AR/VR images corresponding to a plurality of potential viewpoints based on the completed point cloud. In embodiments, the estimated point cloud may correspond to at least one of the estimated point cloud Ŝᵢ and the merged point cloud Sₘ described above. In embodiments, the plurality of potential AR/VR images may be AR images or VR images which are generated based on the at least one of the estimated point cloud Ŝᵢ and the merged point cloud Sₘ. For example, the plurality of potential AR/VR images may be or may include a potential AR image which presents information corresponding to objects in the environment of the user from the perspective of a viewpoint which the user has not yet viewed, or in an area which is hidden from the field of view of the user. As another example, the plurality of potential AR/VR images may be or may include a potential VR image which corresponds to a portion of the environment from the perspective of a viewpoint which the user had not yet viewed, or in an area which is hidden from the field of view of the user. For example, the potential VR image may include a VR object, obstacle, or boundary which corresponds to a real object in the environment a portion of the environment from the perspective of a viewpoint which the user had not yet viewed.

As further shown in FIG. 12A, at operation S1213, the method 1200A may include, based on the user moving from a position corresponding to the current viewpoint to a position corresponding to a potential viewpoint, displaying a transition between a current AR/VR image and a potential AR/VR image to the user. In embodiments, the current AR/VR image may be an AR or VR image corresponding to the current viewpoint of the user, and the potential AR/VR image may be selected from among the plurality of potential AR/VR images obtained in operation S1213. Accordingly, a seamless transition from the current AR/VR image may be provided by the plurality of AR/VR images.

As another example, embodiments described above may be used to manipulate or generate images in a device such as at least one of an AR device, a VR device, a mobile device, a camera, and a computer such as a personal computer, a laptop computer, and a tablet computer. For example, embodiments described above may be used to generate a completed 3D representation of a scene based on a 2D image captured by a camera or an application or other computer program, for example a camera application. Based on the completed 3D representation, a user may generate one or more 2D images from different viewpoints or directions.

In embodiments, the original image used to generate the completed 3D representation may correspond to only a portion of the 2D image. For example, one or more objects may be extracted from the 2D image, and embodiments described above may be used to generate 3D representations of the one or more objects, and new 2D images of the one or more objects may be generated based on input received from a user. For example, the input from the user may be used to select new directions or viewpoints used to generate the 3D representation and the new 2D images.

For example, in some embodiments, the user input may correspond to a manipulation of the 3D representation, and the new 2D images may be generated based on the manipulation being stopped. For example, the user may provide an input such as a dragging gesture which may be used to rotate the 3D representation, and based on the dragging gesture being stopped, one or more new 2D images may be generated based on the rotated 3D representation. As another example, one or more new directions or viewpoints may be predicted in advance, and corresponding new 2D images may be created in advance, and each time the user provides an input such as a dragging gesture, a corresponding 2D image may be displayed to the user.

In addition, embodiments described above may be used to perform scene completion in order to assist with tasks performed by a robot. For example, embodiments described above may be used to plan actions such as grasping for a robotic arm, or to plan movements by a robotic vacuum cleaner.

FIG. 12B is a flowchart illustrating a method 1200B of performing scene completion in at least one of an AR device and a VR device, according to embodiments of the present disclosure. In embodiments, one or more operations of the method 1200B may be performed by or using at least one of the viewpoint module 120, the scene completion system 300, and any of the elements included therein, and any other element described herein.

As shown in FIG. 12B, at operation S1221, the method 1200B may include obtaining an image of an environment of the robot. In embodiments, this current image may correspond to the original RGB-D depth image [symbol] described above. In embodiments, the robot may include a robotic vacuum cleaners, and the environment may include a room which is to be vacuumed by the robotic vacuum cleaner. In embodiments, the drone device such as a flying drone, and the environment may include a scene including an object which is to be observed or picked up by the drone, or an area in which the drone is to place an object. In embodiments, the robot include a robotic arm, and the environment may include a tabletop scene which includes an object to be grasped by the robotic arm.

As further shown in FIG. 12B, at operation S1222, the method 1200B may include performing scene completion to obtain a completed 3D representation of the environment of the robot, for example a completed scene point cloud of a scene included in the environment. In embodiments, the scene completion may correspond to any of the scene completion methods described above.

In embodiments, the completed 3D representation may include predicted areas which are hidden from view in original RGB-D depth image [symbol] . For example, the original RGB-D depth image [symbol] may be captured from the perspective of a robotic vacuum cleaner with a limited vertical field of view, and these predicted areas may be an upper portion of the scene which is not visible to the robotic vacuum cleaner. As another example, the original RGB-D depth image [symbol] may be captured from the perspective of a drone device with a limited vertical field of view, and these predicted areas may be an lower portion of the scene which is not visible to the drone device. As yet another example, the original RGB-D depth image [symbol] may be captured from the perspective of a robotic arm with a limited horizontal field of view, and these predicted areas may be a left and/or right portion of the scene which is not visible to the robotic arm. However, these are provided only as examples, and embodiments are not limited thereto.

As further shown in FIG. 12B, at operation S1223, the method 1200B may include planning a movement of the robot. In embodiments, planning the movement may include planning a route to be taken by the robotic vacuum cleaner in order to vacuum the room. In embodiments, planning the movement may include planning a movement to position the robotic arm to grasp the object.

As another example, based on a robot recognizing an object, the robot may determine a new viewpoint or a portion of the new viewpoint based on a desired rotation direction for the robot, and embodiments described above may be used to generate the a 2D image of the new viewpoint.

As yet another example, based on a robot recognizing an object, the robot may determine a portion of a viewpoint that it expects to see based on anticipating another aspect of the recognized object based on the desired rotation direction, and embodiments described above may be used to generate an image of that portion.

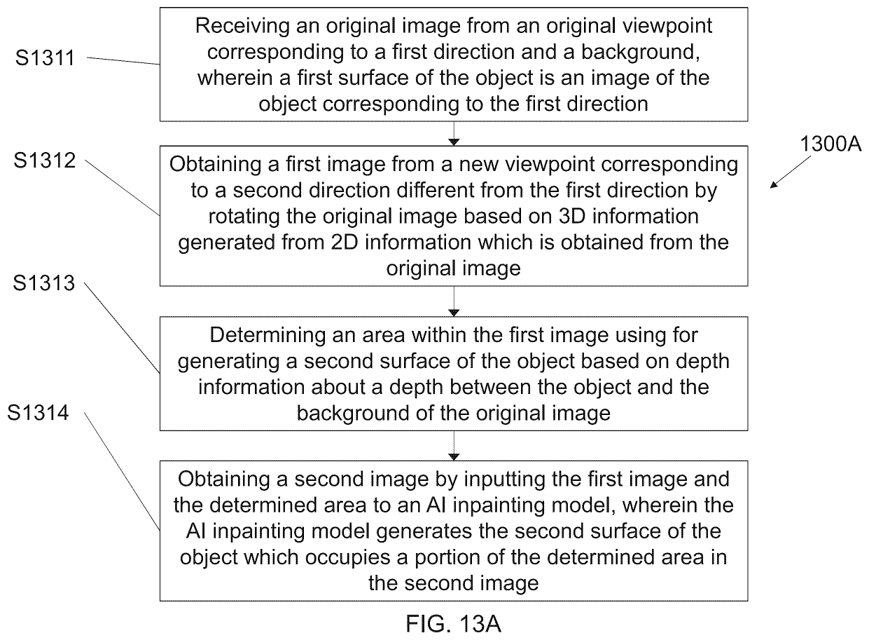

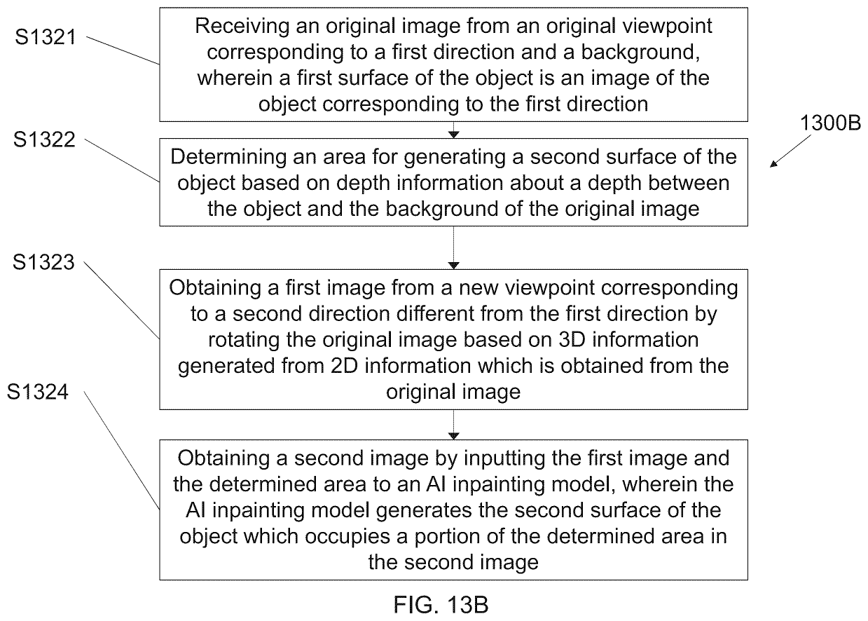

FIG. 13A is a flowchart illustrating a method 1300A of performing scene completion, according to embodiments of the present disclosure. In embodiments, one or more operations of the method 1300A may be performed by or using at least one of the viewpoint module 100, the scene completion system 300, and any of the elements included therein, and any other element described herein.

As shown in FIG. 13A, at operation S1311, the method 1300A may include receiving an original image from an original viewpoint corresponding to a first direction, wherein the scene includes an object and a background, wherein a first surface of the object is an image of the object corresponding to the first direction. In embodiments, the original image may correspond to the RGB-D image J discussed above. In embodiments, the first surface may correspond to the surface 502 in FIG. 5 and the surface 1011 in FIG. 10A as discussed above.

As further shown in FIG. 13A, at operation S1312, the method 1300A may include obtaining a first image from a new viewpoint corresponding to a second direction different from the first direction by rotating the original image based on 3D information generated from 2D information which is obtained from the original image. In embodiments, the 3D information may correspond to the deprojected point cloud discussed above. In embodiments, the first image may correspond to the Īᵢ and the incomplete depth image D̅ᵢ and the new viewpoint may correspond to the new viewpoint Tᵢ discussed above.

As further shown in FIG. 13A, at operation S1313, the method 1300A may include determining an area within the first image for generating a second surface of the object based on depth information about a depth between the object and the background of the original image. In embodiments, In embodiments, the area may correspond to the inappropriate background pixels 508 in FIG. 5 as discussed above. In embodiments, the area within the first image for generating the second surface of the object may correspond to at least one of the mesh 700 and the mesh 1100 discussed above and may correspond to the masking area which done by the SAM module 104 that performs surface-aware masking. In embodiments, the area within the first image may correspond to at least a portion of the background of the original image. Without masking the area, the area may be inadvertently considered to be included in a surface of the object, and the AI inpainting model may therefore inadvertently use inappropriate background pixels when performing inpainting the area within the first image as discussed above with respect to FIGS. 6A to 6C. In embodiments, this area may be one or more areas as discussed above with respect to FIGS. 10A-10C and FIGS. 11A-11C. In embodiments, the area may be masked, and the masked area may be provided to the AI inpainting model. Accordingly, the masked area within the first image may be considered to be the surface of object and may not be considered to be a background area. Therefore, the masked area may be inpainted as a surface of the object.

As further shown in FIG. 13A, at operation S1314, the method 1300A may include generating a second image by inputting the first image and the determined area to an AI inpainting model, wherein the AI inpainting model generates the second surface of the object which occupies a portion of the determined area in the second image. In embodiments, the second image may correspond to the inpainted image discussed above. In embodiments, the second surface of object may correspond to the surface 704 in FIG. 7D. In embodiments, the area in the second image may correspond to the second surface of the object. In embodiments, the second image and the second surface of the object may correspond to a second direction different from the first direction.

FIG. 13B is a flowchart illustrating a method 1300B of performing scene completion, according to embodiments of the present disclosure. In embodiments, one or more operations of the method 1300B may be performed by or using at least one of the viewpoint module 100, the scene completion system 300, and any of the elements included therein, and any other element described herein.

As shown in FIG. 13B, at operation S1321, the method 1300B may include receiving an original image from an original viewpoint corresponding to a first direction, wherein the scene includes an object and a background, wherein a first surface of the object is an image of the object corresponding to the first direction. In embodiments, the original image may correspond to the RGB-D image 7 discussed above. In embodiments, the first surface may correspond to the surface 502 in FIG. 5 and the surface 1011 in FIG. 10A as discussed above.

As further shown in FIG. 13B, at operation S1322, the method 1300B may include determining an area for generating a second surface of the object based on depth information about a depth between the object and the background of the original image. In embodiments, In embodiments, the area may correspond to the inappropriate background pixels 508 in FIG. 5 as discussed above. In embodiments, the area within the first image for generating the second surface of the object may correspond to at least one of the mesh 700 and the mesh 1100 discussed above and may correspond to the masking area which done by the SAM module 104 that performs surface-aware masking. In embodiments, the area may correspond to at least a portion of the background of the original image. Without masking the area, the area may be inadvertently considered to be included in a surface of the object, and the AI inpainting model may therefore inadvertently use inappropriate background pixels when performing inpainting on the area as discussed above with respect to FIGS. 6A to 6C. In embodiments, this area may be one or more areas as discussed above with respect to FIGS. 10A-10C and FIGS. 11A-11C. In embodiments, the area may be masked, and the masked area may be provided to the AI inpainting model. Accordingly, the masked area may be considered to be the surface of object and may not be considered to be a background area. Therefore, the masked area may be inpainted as a surface of the object.

As further shown in FIG. 13B, at operation S1323, the method 1300B may include obtaining a first image from a new viewpoint corresponding to a second direction different from the first direction by rotating the original image based on 3D information generated from 2D information which is obtained from the original image. In embodiments, the 3D information may correspond to the deprojected point cloud discussed above. In embodiments, the first image may correspond to the Īᵢ and the incomplete depth image D̅ᵢ and the new viewpoint may correspond to the new viewpoint Tᵢ discussed above.

As further shown in FIG. 13B, at operation S1324, the method 1300B may include generating a second image by inputting the first image and the determined area to an AI inpainting model, wherein the AI inpainting model generates the second surface of the object which occupies a portion of the determined area in the second image. In embodiments, the second image may correspond to the inpainted image discussed above. In embodiments, the second surface of object may correspond to the surface 704 in FIG. 7D. In embodiments, the area in the second image may correspond to the second surface of the object. In embodiments, the second image and the second surface of the object may correspond to a second direction different from the first direction.

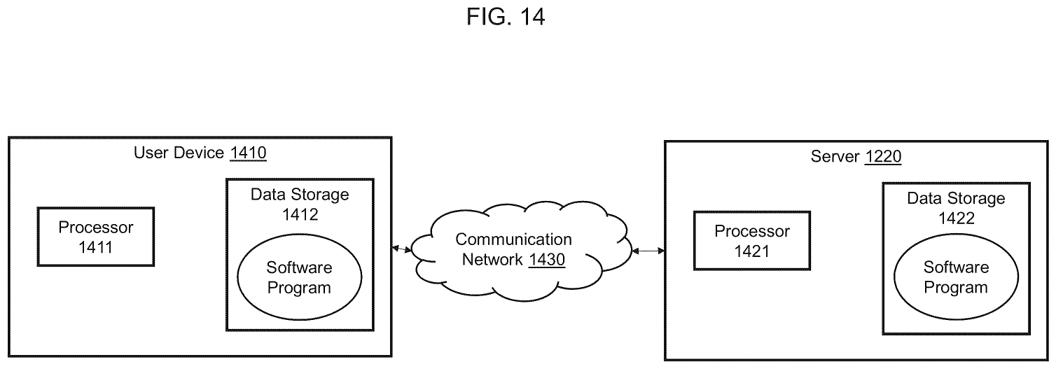

FIG. 14 is a diagram of devices for performing a scene completion task according to embodiments. FIG. 14 includes a user device 1410, a server 1420, and a communication network 1430. The user device 1410 and the server 1420 may interconnect via wired connections, wireless connections, or a combination of wired and wireless connections.

The user device 1410 includes one or more devices (e.g., a processor 1411 and a data storage 1412) configured to retrieve an image corresponding to a search query. For example, the user device 1410 may include a computing device (e.g., a desktop computer, a laptop computer, a tablet computer, a handheld computer, a smart speaker, a server, etc.), a mobile phone (e.g., a smart phone, a radiotelephone, etc.), a camera device, a wearable device (e.g., a pair of smart glasses, a smart watch, etc.), a home appliance (e.g., a robot vacuum cleaner, a smart refrigerator, etc.), or a similar device. The data storage 1412 of the user device 1410 may include one or more of the viewpoint module 100 and the scene completion system 300, or any of the elements included therein. Alternatively, the user device 1410 stores one or more of the viewpoint module 100 and the scene completion system 300, or any of the elements included therein, or vice versa.

The server 1420 includes one or more devices (e.g., a processor 1421 and a data storage 1422) configured to implement one or more of the viewpoint module 100 and the scene completion system 300, or any of the elements included therein. The data storage 1422 of the server 1420 may include one or more of the viewpoint module 100 and the scene completion system 300, or any of the elements included therein. Alternatively, the user device 1410 stores the one or more of viewpoint module 100 and the scene completion system 300, or any of the elements included therein.

The communication network 1430 includes one or more wired and/or wireless networks. For example, network 1430 may include a cellular network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 14 are provided as an example. In practice, there may be additional devices and/or networks, fewer devices and/or networks, different devices and/or networks, or differently arranged devices and/or networks than those shown in FIG. 14. Furthermore, two or more devices shown in FIG. 14 may be implemented within a single device, or a single device shown in FIG. 14 may be implemented as multiple, distributed devices. Additionally, or alternatively, a set of devices (e.g., one or more devices) may perform one or more functions described as being performed by another set of devices.

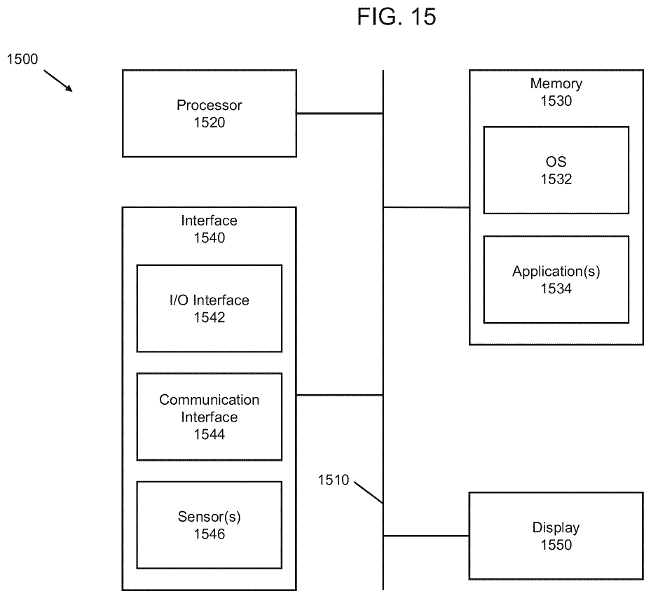

FIG. 15 is a diagram of components of one or more electronic devices of FIG. 14 according to an embodiment. An electronic device 1500 in FIG. 15 may correspond to the user device 1410 and/or the server 1420.

FIG. 15 is for illustration only, and other embodiments of the electronic device 1500 could be used without departing from the scope of this disclosure. For example, the electronic device 1500 may correspond to a client device or a server.

The electronic device 1500 includes a bus 1510, a processor 1520, a memory 1530, an interface 1540, and a display 1550.

The bus 1510 includes a circuit for connecting the components 1520 to 1550 with one another. The bus 1510 functions as a communication system for transferring data between the components 1520 to 1550 or between electronic devices.

The processor 1520 includes one or more of a central processing unit (CPU), a graphics processor unit (GPU), an accelerated processing unit (APU), a many integrated core (MIC), a field-programmable gate array (FPGA), or a digital signal processor (DSP). The processor 1520 is able to perform control of any one or any combination of the other components of the electronic device 1500, and/or perform an operation or data processing relating to communication. For example, the processor 1520 may perform the methods discussed above. The processor 1520 executes one or more programs stored in the memory 1530.

The memory 1530 may include a volatile and/or non-volatile memory. The memory 1530 stores information, such as one or more of commands, data, programs (one or more instructions), applications 1534, etc., which are related to at least one other component of the electronic device 1500 and for driving and controlling the electronic device 1500. For example, commands and/or data may formulate an operating system (OS) 1532. Information stored in the memory 1530 may be executed by the processor 1520.

The applications 1534 include the above-discussed embodiments. These functions can be performed by a single application or by multiple applications that each carry out one or more of these functions. For example, the applications 1534 may include an artificial intelligence (AI) model for performing the methods discussed above.

The display 1550 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 1550 can also be a depth-aware display, such as a multi-focal display. The display 1550 is able to present, for example, various contents, such as text, images, videos, icons, and symbols.

The interface 1540 includes input/output (I/O) interface 1542, communication interface 1544, and/or one or more sensors 1546. The I/O interface 1542 serves as an interface that can, for example, transfer commands and/or data between a user and/or other external devices and other component(s) of the electronic device 1500.

The communication interface 1544 may enable communication between the electronic device 1500 and other external devices, via a wired connection, a wireless connection, or a combination of wired and wireless connections. The communication interface 1544 may permit the electronic device 1500 to receive information from another device and/or provide information to another device. For example, the communication interface 1544 may include an Ethernet interface, an optical interface, a coaxial interface, an infrared interface, a radio frequency (RF) interface, a universal serial bus (USB) interface, a Wi-Fi interface, a cellular network interface, or the like. The communication interface 1544 may receive videos and/or video frames from an external device, such as a server.

The sensor(s) 1546 of the interface 1540 can meter a physical quantity or detect an activation state of the electronic device 1500 and convert metered or detected information into an electrical signal. For example, the sensor(s) 1546 can include one or more cameras or other imaging sensors for capturing images of scenes. The sensor(s) 1546 can also include any one or any combination of a microphone, a keyboard, a mouse, and one or more buttons for touch input. The sensor(s) 1546 can further include an inertial measurement unit. In addition, the sensor(s) 1546 can include a control circuit for controlling at least one of the sensors included herein. Any of these sensor(s) 1546 can be located within or coupled to the electronic device 1500. The sensor(s) 1546 may receive a text and/or a voice signal that contains one or more queries.

The scene completion processes and methods described above may be written as computer-executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 1500, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The scene completion methods and processes may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated.

The foregoing disclosure provides illustration and description, but is not intended to be exhaustive or to limit the implementation to the precise form disclosed. Modifications and variations are possible in light of the above disclosure or may be acquired from practice of the implementation.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

A model related to the neural networks described above may be implemented via a software module. When the model is implemented via a software module (for example, a program module including instructions), the model may be stored in a computer-readable recording medium.

Also, the model may be a part of the electronic device 1400 described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU).

Also, the model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

While the embodiments of the disclosure have been described with reference to the figures, it will be understood by those of ordinary skill in the art that various changes in form and details may be made therein without departing from the spirit and scope as defined by the following claims.

What is claimed is:

1. A method for processing image data for scene completion, the method being executed by at least one processor and comprising:
receiving an original image from an original viewpoint corresponding to a first direction, wherein the original image includes an object and a background, wherein a first surface of the object is an image of the object corresponding to the first direction;
obtaining a first image from a new viewpoint corresponding to a second direction different from the first direction by rotating the original image based on 3-dimensional (3D) information generated from 2-dimensional (2D) information which is obtained from the original image;
determining an area within the first image for generating a second surface of the object based on depth information about a depth between the object and the background of the original image; and
obtaining a second image by inputting the first image and the determined area to an artificial intelligence (AI) inpainting model, wherein the AI inpainting model generates the second surface of the object which occupies a portion of the determined area in the second image.

2. The method of claim 1, further comprising:
rendering an incomplete color image and an incomplete depth image corresponding to the new viewpoint based on the 3D information;
masking a portion of the incomplete color image based on the 3D information and the incomplete depth image to obtain a masked color image, wherein the masked portion of the incomplete color image corresponds to the determined area and indicates that the masked portion of the incomplete color image is obscured by the object when the scene is viewed from the new viewpoint; and
inpainting the masked color image to obtain the second image.

3. The method of claim 2, wherein the obtaining the second image comprises:
inpainting the masked color image based on the AI inpainting model to obtain the second image.

4. The method of claim 3, further comprising:
obtaining an image caption by providing the second image to an AI caption model; and
determining whether to re-inpaint the second image by comparing an embedding of the image caption and an embedding of the prompt.

5. The method of claim 3, further comprising:
masking a portion of the incomplete depth image based on the 3D information and the incomplete depth image to obtain a masked depth image, wherein the masked portion of the incomplete depth image corresponds to the determined area;
providing the second image to an AI depth estimation model;
generating an estimated depth image based on the masked depth image and an output of the AI depth estimation model; and
generating a completed 3D representation based on the second image and the estimated depth image.

6. The method of claim 5, wherein the generating the estimated depth image comprises:
obtaining at least one estimated normal and at least one estimated occlusion boundary by providing the second image to the AI depth estimation model; and
obtaining the estimated depth image based on the incomplete depth image, the at least one estimated normal, and the at least one estimated occlusion boundary.

7. The method of claim 5, further comprising:
rendering a plurality of incomplete color images and a plurality of incomplete depth images from a plurality of new viewpoints based on the 3D information;
masking the plurality of incomplete color images to obtain a plurality of masked color images, and masking the plurality of incomplete depth images to obtain a plurality of masked depth images;
obtaining a plurality of second images by providing the plurality of masked color images to the AI inpainting model;
providing the plurality of second images to the AI depth estimation model; and
obtaining a plurality of estimated depth images based on the plurality of masked depth images and a plurality of outputs of the AI depth estimation model,
wherein the completed 3D representation is further generated based on the plurality of second images and the plurality of estimated depth images.

8. The method of claim 7, wherein the generating of the completed 3D representation comprises:
generating a plurality of estimated point clouds based on the second image, the estimated depth image, the plurality of second images, and the plurality of estimated depth images; and
merging the plurality of estimated point clouds by discarding points which are not included in at least two estimated point clouds from among the plurality of estimated point clouds to obtain a completed scene point cloud representing the scene.

9. The method of claim 2, wherein the masking comprises:
generating a plurality of points which extend beyond a surface included in the original image;
generating a mesh based on the plurality of points;
rendering a depth map representing the mesh from the new viewpoint;
generating a mask based on a comparison between the incomplete depth image and the depth map; and
applying the mask to the incomplete color image.

10. The method of claim 9, wherein the mask indicates a plurality of pixels which are not used for generating the second image, and
wherein the plurality of pixels includes a first plurality of pixels for which a depth is not indicated by the incomplete depth image, and a second plurality of pixels for which a depth indicated by the incomplete depth image is greater than a depth indicated by the depth map.

11. The method of claim 1, wherein the original image is captured by at least one of an augmented reality (AR) device and a virtual reality (VR) device,
wherein the original viewpoint comprises a current viewpoint of a user, and the original image corresponds to a current AR/VR image displayed to the user, and
wherein the method further comprises:
obtaining a completed 3D representation of the scene based on the second image;
obtaining a potential AR/VR image based on the completed 3D representation, wherein the potential AR/VR image corresponds to a potential viewpoint of the user; and
based on the user moving from a position corresponding to the current viewpoint to a position corresponding to the potential viewpoint, displaying a transition between the current AR/VR image and the potential AR/VR image to the user.

12. The method of claim 1, wherein the original image is captured by a robot, and
wherein the method further comprises planning a movement path for the robot based on the second image.

13. An electronic device for processing image data for scene completion, the electronic device comprising:
at least one memory configured to store instructions; and
at least one processor configured to execute the instructions to:
receive an original image from an original viewpoint corresponding to a first direction, wherein the original image includes an object and a background, wherein a first surface of the object is an image of the object corresponding to the first direction,
obtain a first image from a new viewpoint corresponding to a second direction different from the first direction by rotating the original image based on 3-dimensional (3D) information generated based on 2-dimensional information which is obtained from the original image,
determine an area with the first image for generating a second surface of the object based on depth information about a depth between the object and the background of the original image; and
obtain a second image by inputting the first image and the determined area to an artificial intelligence (AI) inpainting model, wherein the AI inpainting model generates the second surface of the object which occupies a portion of the determined area in the second image.

14. The electronic device of claim 13, wherein the at least one processor is further configured to execute the instructions to:
render an incomplete color image and an incomplete depth image corresponding to the new viewpoint based on the 3D information,
mask a portion of the incomplete color image based on the 3D information and the incomplete depth image to obtain a masked color image, wherein the masked portion of the incomplete color image corresponds to the determined area and indicates that the masked portion of the incomplete color image is obscured by the object when the scene is viewed from the new viewpoint, and
inpaint the masked color image to obtain the second image.

15. The electronic device of claim 14, wherein to inpaint the masked color image, the at least one processor is further configured to execute the instructions to:
inpaint the masked color image based on the AI inpainting model to obtain the second image.

16. The electronic device of claim 15, wherein the at least one processor is further configured to execute the instructions to:
obtain an image caption by providing the second image to an AI caption model; and
determine whether to re-inpaint the second image by comparing an embedding of the image caption and an embedding of the prompt.

17. The electronic device of claim 15, wherein the at least one processor is further configured to execute the instructions to:
mask a portion of the incomplete depth image based on the 3D information and the incomplete depth image to obtain a masked depth image, wherein the masked portion of the incomplete depth image corresponds to the determined area;
provide the second image to an AI depth estimation model;
generate an estimated depth image based on the masked depth image and an output of the AI depth estimation model; and
generate a completed 3D representation based on the second image and the estimated depth image.

18. The electronic device of claim 17, to generate the estimated depth image the at least one processor is further configured to execute the instructions to:
obtain at least one estimated normal and at least one estimated occlusion boundary by providing the second image to the AI depth estimation model; and
obtain the estimated depth image based on the incomplete depth image, the at least one estimated normal, and the at least one estimated occlusion boundary.

19. The electronic device of claim 17, wherein the at least one processor is further configured to execute the instructions to:
render a plurality of incomplete color images and a plurality of incomplete depth images from a plurality of new viewpoints based on the 3D information;
mask the plurality of incomplete color images to obtain a plurality of masked color images, and masking the plurality of incomplete depth images to obtain a plurality of masked depth images;
obtain a plurality of second images by providing the plurality of masked color images to the AI inpainting model;
provide the plurality of second images to the AI depth estimation model; and
obtain a plurality of estimated depth images based on the plurality of masked depth images and a plurality of outputs of the AI depth estimation model;
wherein the completed 3D representation is further generated based on the plurality of second images and the plurality of estimated depth images.

20. The electronic device of claim 19, wherein to generate the completed 3D representation, the at least one processor is further configured to execute the instructions to:
generate a plurality of estimated point clouds based on the second image, the estimated depth image, the plurality of second images, and the plurality of estimated depth images; and
merge the plurality of estimated point clouds by discarding points which are not included in at least two estimated point clouds from among the plurality of estimated point clouds.

21. The electronic device of claim 14, wherein to mask the incomplete color image, the at least one processor is further configured to execute the instructions to:
generate a plurality of points which extend beyond a surface included in the original image;
generate a mesh based on the plurality of points;
render a depth map representing the mesh from the new viewpoint;
generate a mask based on a comparison between the incomplete depth image and the depth map; and
apply the mask to the incomplete color image.

22. The electronic device of claim 21, wherein the mask indicates a plurality of pixels which are not used for generating the second image, and
wherein the plurality of pixels includes a first plurality of pixels for which a depth is not indicated by the incomplete depth image, and a second plurality of pixels for which a depth indicated by the incomplete depth image is greater than a depth indicated by the depth map.

23. The electronic device of claim 13, wherein the original image is captured by at least one of an augmented reality (AR) device and a virtual reality (VR) device,
wherein the original viewpoint comprises a current viewpoint of a user, and the original image corresponds to a current AR/VR image displayed to the user, and
wherein the at least one processor is further configured to execute the instructions to:
obtain a completed 3D representation of the scene based on the second image;
obtain a potential AR/VR image based on the completed 3D representation, wherein the potential AR/VR image corresponds to a potential viewpoint of the user; and
based on the user moving from a position corresponding to the current viewpoint to a position corresponding to the potential viewpoint, display a transition between the current AR/VR image and the potential AR/VR image to the user.

24. The electronic device of claim 13, wherein the original image is captured by a robot, and
wherein the at least one processor is further configured to execute the instructions to plan a movement path for the robot based on the second image.

25. A non-transitory computer-readable medium configured to store instructions which, when executed by at least one processor of a device for processing image data for scene completion, cause the at least one processor to:
receive an original image from an original viewpoint corresponding to a first direction, wherein the original image includes an object and a background, wherein a first surface of the object is an image of the object corresponding to the first direction;
obtaining a first image from a new viewpoint corresponding to a second direction different from the first direction by rotating the original image based on 3-dimensional (3D) information generated from 2-dimensional information about the scene which is obtained from the original image;
determine an area within the first image for generating a second surface of the object based on depth information about a depth between the object and the background of the original image; and
obtain a second image by inputting the first image and the determined area to an artificial intelligence (AI) inpainting model, wherein the AI inpainting model generates the second surface of the object which occupies a portion of the determined area in the second image.

26. The non-transitory computer-readable medium of claim 25, wherein the instructions further cause the at least one processor to:
render an incomplete color image and an incomplete depth image corresponding to the new viewpoint based on the 3D information;
mask a portion of the incomplete color image based on the 3D information and the incomplete depth image to obtain a masked color image, wherein the masked portion of the incomplete color image corresponds to the determined area and indicates that the masked portion of the incomplete color image is obscured by the object when the scene is viewed from the new viewpoint; and
inpaint the masked color image to obtain the second image.

27. The non-transitory computer-readable medium of claim 26, wherein the instructions further cause the at least one processor to:
inpaint the masked color image based on the AI inpainting model to obtain the second image.
